(19) United States
(12) Patent Application Publication
(10) Pub. No.: US 2015/0065660 A1
(43) Pub. Date: Mar. 5, 2015

(54) METHODS FOR SEPARATING MIXTURES OF COMPOUNDS

(71) Applicant: UNIVERSITY OF IOWA RESEARCH FOUNDATION, Iowa City, IA (US)

(72) Inventors: Ned B. Bowden, Iowa City, IA (US); Abhinaba Gupta, Iowa City, IA (US)

(21) Appl. No.: 14/477,749

(22) Filed: Sep. 4, 2014

Related U.S. Application Data
(60) Provisional application No. 61/874,243, filed on Sep. 5, 2013.

(51) Int. Cl. C11B 7/00; C08F 132/08

(52) U.S. Cl. CPC C11B 7/00; C08F 132/08
USPC 525/332.1; 554/212; 422/261

(57) ABSTRACT

The invention provides methods and membranes for separating mixtures of two or more compounds such as fatty acids or fatty acid esters.

### CROSS-REFERENCE TO RELATED APPLICATIONS

This patent application claims the benefit of priority of U.S. application Ser. No. 61/874243, filed Sep. 5, 2013, which application is herein incorporated by reference.

### GOVERNMENT FUNDING

This invention was made with government support under NSF-CHE-0848162 and NSF-CHE-1213325 awarded by the National Science Foundation. The government has certain rights in the invention.

### BACKGROUND OF THE INVENTION

Fatty acids are the main component of vegetable, tall, and marine oils (Scheme 1). The oils are readily hydrolyzed to yield glycerol and a mixture of four, five, or more free fatty acids. The composition of the fatty acids is mostly determined by the source of the oil and different oils have different compositions. For instance, soybean oil is 10% palmitic acid, 4% stearic acid, 18% oleic acid, 55% linoleic acid, and 13% linolenic acid, but other oils have higher or lower amounts of these and other fatty acids. When oils are hydrolyzed, the mixture of fatty acids that is isolated is identical or very similar to the mixture of fatty acids found in the original oil. For instance, linoleic acid is 55% of soybean oil and when soybean oil is hydrolyzed and the free fatty acids isolated, the mixture of free fatty acids contains approximately 55% linoleic acid. Methods exist that can separate glycerol from fatty acids on a scale of millions of tons per year, but the fatty acids directly isolated from oils are always a mixture of fatty acids. A major challenge in the field of oleochemicals is that although a mixture of fatty acids can be readily isolated from oils, separating a mixture of fatty acids into individual fatty acids or a mixture enriched in one or more fatty acids is very challenging. The same challenges exist when oils are converted into esters such as their alkyl esters (e.g., ethyl esters). The composition of fatty acid ethyl esters is similar to the composition of fatty acid in the oils and separating them is challenging.

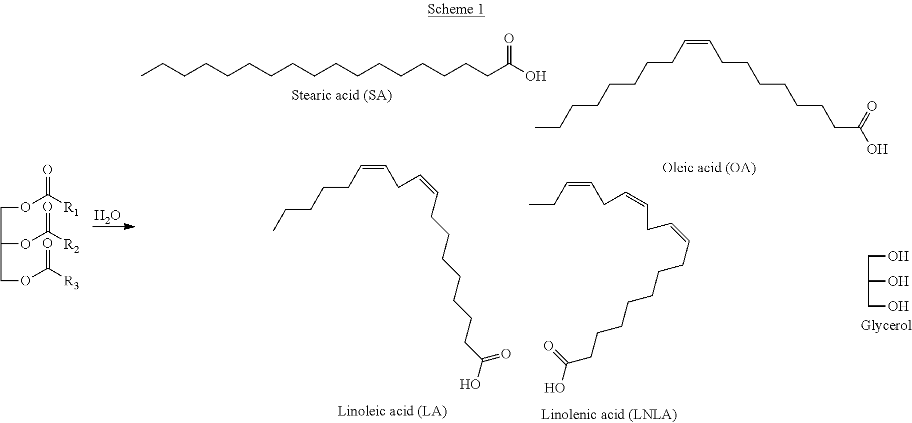

Vegetable and tall oils react with alcohols to yield fatty acid esters that are used as biodiesel (Scheme 2). Not all fatty acid esters are highly desired in biodiesel and different mixtures of fatty acid esters are needed for different climates. Fatty acid esters have different melting points and stabilities that affect the performance of biodiesel and how it can be used. For instance, the methyl ester of stearic acid has a melting point of 37-41° C. Biodiesels with a high content of this ester have a cloud temperature that is too high for vehicles in cold or even moderately warm climates. The cloud temperature of biodiesel is when one (or more) components precipitate to yield solids that cause engine problems and are undesired. The methyl ester of oleic acid (melting point: −20° C.), methyl ester of linoleic acid (melting point: −35° C.), and methyl ester of linolenic acid (melting point: −35° C.) all have significantly lower melting points and significantly lower cloud temperatures. Biodiesels high in polyunsaturated fatty acid esters are desired for cold climates, but undesired in hot climates because polyunsaturated fatty acid esters can be oxidized at elevated temperatures to yield solids that cause engine problems. Polyunsaturated fatty acid esters are those that contain two or more double bonds.

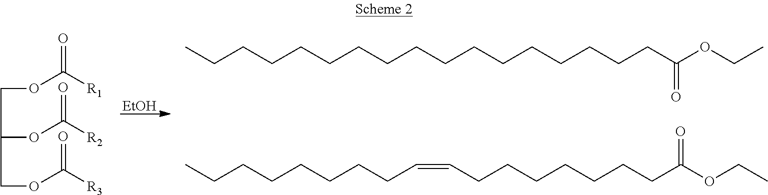

One challenge in the field of biodiesel is that the composition of biodiesel must be altered for different environments, but this cannot be easily accomplished using fatty acid esters from one oil source because while mixtures of fatty acid esters are easily obtained from oils, economically separating these mixtures into individual components or a mixture enriched in one or more fatty acid esters is very challenging.

Methods to separate mixtures of fatty acids or fatty acid esters into individual components include the use of silver chromatography, high performance liquid chromatography, winterization (with or without additives such as urea), and distillation. In one example, a separation would enrich linoleic acid derived from soybean oil. When soybean oil is hydrolyzed to release the free fatty acids, the mixture of fatty acids is approximately 55% linoleic acid. A separation of the fatty acids would enrich one component to >55% linoleic acid. In another example, such separations include the separation of a mixture of 33% stearic acid, 33% oleic acid, and 34% linoleic acid) into individual components (such as a component that is enriched in stearic, oleic, or linoleic acid).

Current methods to separate fatty acids are either not readily scaled up to separate many tons of material, are energy intensive, or have rapidly escalating costs as the final purity of fatty acids is increased. For instance, the high energy costs for distillation add significant cost to the separation process and led to increased costs for the fatty acids or fatty acid esters purified using distillation. Silver chromatography and high performance liquid chromatography also add significant cost to the purified fatty acids and fatty acid esters as well as not being readily scaled up to separate multiton quantities of material in one day. Winterization requires large amounts of solvent, careful control of temperature, and may require repeated crystallizations. The ultimate purities of fatty acids purified using winterization are limited to low to moderate purities. These methods are all used industrially, but they either can only be used to reach moderate purities at modest price increases or they are not economically viable for to isolate industrial quantities of single component fatty acids or fatty acid esters or enriched mixtures of fatty acids or fatty acid esters. The sale of oleic, linoleic, and linolenic acids at moderate purities of 60-80% are approximately 1,000 USD per 1,000 kilograms, but because of the high cost of purifying fatty acids and fatty acid esters, the cost of high purity (98-99% pure) fatty acids and fatty acid esters is significantly higher.

The challenges of separating fatty acids derived from marine sources illustrate the challenges in this field. Eicosapenteanoic acid (EPA) and docosahexaenoic acid (DHA) are two of the omega-3 fatty acids found in fish oil and algal oil (Scheme 3). These fatty acids are isolated as a mixture with other fatty acids when marine oils are hydrolyzed with water. Most separations of these acids occurs when they have been converted in the ethyl esters, and the ethyl esters are also challenging to isolate at elevated purities. It is very challenging to separate EPA-EE (EPA-Ethyl Ester, ethyl eicosapenteanoate) and DHA-EE (DHA-Ethyl Ester, ethyl docosahexaenoate) from each other because of their similar structures and sensitivity to oxygen and elevated temperatures. Both EPA-EE and DHA-EE are sensitive to oxidation because of their high degrees of polyunsaturation which makes purifying them by distillation very challenging and impractical on a large scale. In fact, these esters are prone to oxidation even when exposed to atmospheric conditions at room temperature. Although moderate purity samples of EPA-EE and DHA-EE are available for 10 USD per gram or less, high purity (99% pure) samples cost 10,000 USD per gram for EPA-EE and 358 USD per gram for DHA-EE due in large part to the challenges of purifying these esters (Sigma-Aldrich prices).

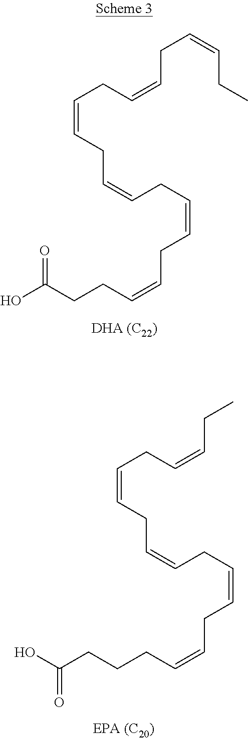 [SMILES: CC/C=C\C/C=C\C/C=C\C/C=C\C/C=C\C/C=C\CCC(=O)O ; CC/C=C\C/C=C\C/C=C\C/C=C\C/C=C\CCCC(=O)O]

Fatty acids and fatty acid esters are difficult to separate because they possess similar molecular weights, the same set of functional groups, and fluxional structures. The molecular weights of the five fatty acids in soybean are 256 g/mol (palmitic acid), 284 g/mol (stearic acid), 282 g/mol (oleic acid), 280 g/mol (linoleic acid), and 278 g/mol (linolenic acid). Because these molecular weights are very similar, many of the key physical properties such as boiling points, solubilities, and densities are similar and do not provide a simple basis for separation to reach high purities. Separations (i.e. distillation and winterization) based on these key physical properties are mature technologies. A simple separation of fatty acids might be possible if they possessed different functional groups, but all fatty acids possess 0, 1, 2, or more carbon-carbon double bonds and a carboxylic acid, so their functional groups are similar. Another challenge to developing a separation method is that these molecules have fluxional structures. Each carbon-carbon single bond can freely rotate so each fatty acid can assume many different conformations (Scheme 4). These conformations will have different energies and be populated at different levels. The large number of different conformations makes describing typical conformations and sizes of fatty acids complex.

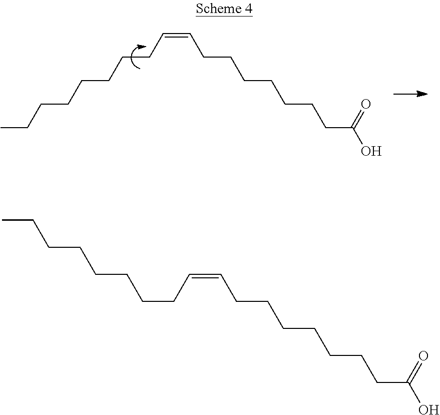 [SMILES: CCCCCCCC/C=C\CCCCCCCC(=O)O ; CCCCCCCC/C=C\CCCCCCCC(=O)O]

It would be highly desired to separate mixtures of fatty acids or fatty acid esters using nanoporous membranes. The development of a membrane-based method to separate mixtures of fatty acid and fatty acid esters into single components or enriched mixtures would be an economically viable method to produce industrial quantities at a reasonable price. Membrane separations are inexpensive, easy to implement, and readily scaled up to separate many tons of material. The challenge in the field of oleochemicals is that fatty acids have very similar structures, molecular weights, and structures so they have not been separated by any membrane. Because of the similarities between two or more fatty acid esters, mixtures of the esters have also not been separated using nanoporous membranes.

Nanoporous membranes (such as organic solvent nanofiltration membranes) have been used to separate organic molecules with large differences in molecular weight. These membranes are described as possessing a molecular weight cutoff (MWCO) which is defined as the molecular weight above which at least 90% of a molecule will be rejected by a membrane. Simply, above the MWCO a molecule is mostly rejected (or retained) by a membrane and below this MWCO a molecule can permeate the membrane. The separation of molecules using these membranes is typically successful when two or more molecules have large differences in their molecular weights because molecules with similar molecular weights may be rejected at similar rates by a membrane. A large difference in molecular weights is highly desired to ensure that one molecule is mostly retained while the other passes through the membrane quickly. This presents a problem in the separation of fatty acids and fatty acid esters because they have similar molecular weights. Prior attempts to separate mixtures of fatty acids and fatty acid esters into individual components failed as predicted based on the use of a MWCO.

Molecular weights are used to define a MWCO because of the ease of measuring a molecular weight compared to difficulties in measuring a cross-sectional area for a molecule.

Molecules have many different cross-sectional areas depending on the conformation and angle at which a molecule is viewed. When the concept of a cross-sectional area is discussed as it relates to the ability of a molecule to permeate a membrane, the smallest cross-sectional area of the lowest energy conformation is typically viewed as the most important. This cross-sectional area is referred to as the “critical area”. For instance, a basketball and a frisbee have similar cross-sectional areas when the frisbee is viewed down one axis, but if a frisbee is viewed along its edge it will have a much smaller cross-sectional area. A frisbee would fit through openings that a basketball would not fit through. The smallest cross-sectional area of the frisbee would be called its critical area. For nanoporous membranes, the critical area can be used to predict the approximate size of a pore through which the molecule may readily pass through.

The critical areas of the fatty acids and fatty acid esters are similar and below 0.40 nm² (Table 1) ((1) Long, T. R.; Gupta, A.; Miller II, A. L.; Rethwisch, D. G.; Bowden, N. B. J. Mater. Chem. 2011, 21, 14265; (2) Gupta, A.; Rethwisch, D. G.; Bowden, N. B. Chem. Commun. 2011, 46, 10236). The critical areas in Table 1 were measured from each molecule in its lowest energy conformation. The critical areas were the orientation with the lowest cross-sectional area when the molecule was in its lowest energy configuration. Since free rotation about the carbon-carbon single bonds is possible, the molecules can assume many different conformations with different cross-sectional areas. The fatty acids and fatty acid esters are highly fluxional with different conformations that possess different cross-sectional areas. This increases the complexity and challenge of separating fatty acids and fatty acid esters from one another.

TABLE 1
The critical areas of the fatty acids and fatty acid esters.

| Molecule | Critical area (nm²) |
|---|---|
| Stearic acid | 0.067 |
| Palmitic acid | 0.067 |
| Oleic acid | 0.21 |
| Linoleic acid | 0.34 |
| Linolenic acid | 0.36 |
| Stearic acid methyl ester | 0.067 |
| Palmitic acid methyl ester | 0.067 |
| Oleic acid methyl ester | 0.21 |
| Linoleic acid methyl ester | 0.34 |
| Linolenic acid methyl ester | 0.36 |

The separation of mixtures of fatty acids and mixtures of fatty acid esters has not been successful using nanoporous membranes because of their nearly identical molecular weights, highly fluxional structures, and low critical areas. In fact, the use of a MWCO predicts that membranes will not be successful at separating fatty acids or their esters because of their similar molecular weights.

For these reasons and more, methods for separating mixtures of fatty acids or fatty acid esters using nanoporous membranes have not been developed. The lack of methods to separate fatty acids and fatty acid esters by membranes is a significant problem as membrane separations are typically inexpensive, not energy intensive, and can be applied to many tons of material. Therefore, there is a need to develop membrane-based methods to separate mixtures of fatty acids into single fatty acids or into mixtures of fatty acids wherein the mixtures are enriched in one or more of the fatty acids. There is also a need to develop membrane-based methods to separate mixtures of fatty acid esters into single fatty acid esters or into mixtures of fatty acid esters wherein the mixtures are enriched in one or more of the fatty acid esters.

### SUMMARY OF THE INVENTION

Applicant has discovered that when polydicyclopentadiene (such as the polydicyclopentadiene discussed in (1) Long, T. R.; Gupta, A.; Miller II, A. L.; Rethwisch, D. G.; Bowden, N. B. J Mater. Chem. 2011, 21, 14265; (2) Gupta, A.; Rethwisch, D. G.; Bowden, N. B. Chem. Commun. 2011, 46, 10236 and (3) U.S. Pat. No. 8,778,186) is further treated with a reagent capable of crosslinking one or more double bonds of the polydicyclo-pentadiene (e.g., a cross-linking reagent) such as a radical initiator or a cation initiator a highly crosslinked polydicyclopentadiene is formed and that this highly crosslinked polydicyclopentadiene is an effective membrane for separating mixtures of a variety of compounds including mixtures of fatty acids and fatty acid esters. This discovery represents a significant new method to separate mixtures of compounds. One such method involves the separation of a mixture of fatty acids to isolate individual fatty acids or mixtures of two or more fatty acids which are enriched in at least one fatty acid. This discovery also represents a significant new method to separate mixtures of fatty acid esters to isolate individual fatty acid esters or mixtures of two or more fatty acid esters which are enriched in at least one fatty acid ester.

Accordingly, one embodiment provides a method comprising contacting a highly crosslinked polydicyclopentadiene membrane with a mixture of two or more different compounds, so that the mixture is fractionated into a permeate and a retentate, wherein the permeate or retentate is enriched in one or more of the compounds, and wherein the highly crosslinked polydicyclopentadiene membrane is obtainable by (a) contacting polydicyclopentadiene with a reagent capable of crosslinking two or more double bonds of the polydicyclopentadiene or (b) contacting dicyclopentadiene with a ring-opening polymerization catalyst and a reagent capable of crosslinking two or more double bonds of polydicyclopentadiene.

Another embodiment provides a method for separating a mixture of two or more different fatty acids or two or more different fatty acid esters comprising:

(a) contacting a membrane with a mixture of two or more different fatty acids, so that the mixture is fractionated into a permeate and a retentate, wherein the permeate or retentate is enriched in one or more different fatty acids; or

(b) contacting a membrane with a mixture of two or more different fatty acid esters, so that the mixture is fractionated into a permeate and a retentate, wherein the permeate or retentate is enriched in one or more different fatty acid esters.

Another embodiment provides a highly crosslinked polydicyclopentadiene composite membrane wherein the highly crosslinked polydicyclopentadiene membrane is in contact with a porous support backing material and wherein the highly crosslinked polydicyclopentadiene membrane is obtainable by (a) contacting polydicyclopentadiene with a reagent capable of crosslinking two or more double bonds of the polydicyclopentadiene or (b) contacting dicyclopentadiene with a ring-opening polymerization catalyst and a reagent capable of crosslinking two or more double bonds of polydicyclopentadiene.

Another embodiment provides a highly crosslinked polydicyclopentadiene composite membrane wherein the highly crosslinked polydicyclopentadiene membrane is in contact with a porous support backing material and wherein the highly crosslinked polydicyclopentadiene membrane is obtainable by contacting a polydicyclopentadiene with a reagent to crosslink two or more double bonds of the polydicyclopentadiene.

Another embodiment provides a highly crosslinked polydicyclopentadiene membrane wherein the highly crosslinked polydicyclopentadiene membrane is obtainable by (a) contacting polydicyclopentadiene with a reagent capable of crosslinking two or more double bonds of the polydicyclopentadiene or (b) contacting dicyclopentadiene with a ring-opening polymerization catalyst and a reagent capable of crosslinking two or more double bonds of polydicyclopentadiene.

### BRIEF DESCRIPTION OF THE FIGURES

FIG. 1 illustrates a cross-sectional schematic of an apparatus that was used to measure permeation through some highly crosslinked polydicyclopentadiene membranes. Molecules A and B were initially added to the solvent upstream of the membrane and only molecule A permeated to the downstream solvent (i.e., the permeate).

### DETAILED DESCRIPTION

Alkyl as used herein in includes straight and branched saturated hydrocarbon chains. For example, an alkyl group can have 4 to 28 carbon atoms (i.e., (C₄-C₂₈)alkyl) or 1 to 18 carbon atoms (i.e., (C₁-C₁₈)alkyl) or any specified number or carbon atoms.

The term “heteroalkyl” as used herein refers to an alkyl as defined herein, wherein one or more (e.g., 1, 2, 3, 4 or 5) of the carbon atoms of the alkyl are replaced by an O, S, or NR^{q}, (or if the carbon atom being replaced is a terminal carbon with an OH, SH or N(R^{q})₂) wherein each R^{q} is independently H or (C₁-C₆)alkyl. For example, (C₁-C₁₈)heteroalkyl includes a heteroalkyl of one to eighteen carbons and one or more (e.g., 1, 2, 3, 4 or 5) heteroatoms (e.g., O, S, NR^{q}, OH, SH or N(R^{q})₂). Examples of heteroalkyls include but are not limited to methoxymethyl, ethoxymethyl, methoxy, 2-hydroxyethyl and N,N′-dimethylpropylamine.

Alkenyl as used herein includes straight and branched hydrocarbon chains that comprise one or more carbon-carbon double bonds. For example, an alkyl group can have 1 to 18 carbon atoms (i.e., (C₁-C₁₈)alkenyl) or any specified number or carbon atoms.

The term “heteroalkenyl” as used herein refers to an alkenyl as defined herein, wherein one or more (e.g., 1, 2, 3, 4 or 5) of the carbon atoms of the alkenyl are replaced by an O, S, or NR^{q}, (or if the carbon atom being replaced is a terminal carbon with an OH, SH or N(R^{q})₂) wherein each R^{q} is independently H or (C₁-C₆)alkyl. For example, (C₁-C₁₈)heteroalkenyl includes a heteroalkenyl of one to eighteen carbons and one or more (e.g., 1, 2, 3, 4 or 5) heteroatoms (e.g., O, S, NR^{q}, OH, SH or N(R^{q})₂).

Halo or halogen as used herein includes fluoro, chloro, bromo and iodo.

The term “enriched” as used herein with term retentate means that the ratio of one or more compounds (e.g., one or more fatty acids or one or more fatty acid esters) versus other compounds (e.g., fatty acids or fatty acid esters) in the retentate is greater than the corresponding ratio of the permeate and/or the mixture from which the retentate and permeate were derived. In the same manner the term “enriched” as used herein with term permeate means that the ratio of one or more compounds (e.g., one or more fatty acids or one or more fatty acid esters) versus other compounds (e.g., fatty acids or fatty acid esters) in the permeate is greater than the corresponding ratio in the retentate and/or the mixture from which the retentate and the permeate were derived. Accordingly, the permeate may be enriched in one or more compounds (e.g., fatty acids or fatty acid esters) when compared to the corresponding retentate or the mixture from which the permeate was derived. Likewise, the retentate may be enriched in one or more compounds (e.g., fatty acids or fatty acid esters) when compared to the corresponding permeate or the mixture from which the retentate was derived.

### Highly Cross-Linked Polydicyclopentadiene Membranes

The “highly cross-linked polydicyclopentadiene membranes” used herein are semipermeable materials which can be used to separate components of a mixture into a permeate that passes through the membrane and a retentate that is rejected or retained by the membrane. These membranes are compatible with organic solvents.

The highly cross-linked polydicyclopentadiene membranes of the present invention are prepared from polydicyclopentadienes (e.g., first polydicyclopentadiene) such as those discussed in (1) Long, T. R.; Gupta, A.; Miller II, A. L.; Rethwisch, D. G.; Bowden, N. B. J Mater. Chem. 2011, 21, 14265; (2) Gupta, A.; Rethwisch, D. G.; Bowden, N. B. Chem. Commun. 2011, 46, 10236; and (3) U.S. Pat. No. 8,778,186 all of which references are hereby incorporated in their entirety). The polydicyclopentadienes (e.g., polydicyclopentadiene membranes) discussed in these documents have sub-nm and nm-sized pores and can also be used with organic solvents. Molecules with critical areas of 0.50 nm² or larger have slow permeation through such membranes, but molecules with critical areas of 0.40 nm² or lower have fast permeation. Stearic, oleic, linoleic, linolenic, eicosapentaenoic, and docosahexaenoic acids passed through such a polydicyclopentadiene (PDCPD) membrane permeated at the same or very similar rates. The PDCPD membranes could not separate a mixture of these fatty acids. A similar trend was observed for a mixture of fatty acid esters. This result was consistent with the cross-sectional areas of these acids which were all lower than 0.40 nm² (Table 1).

It has been discovered that these previously described PDCPD membranes can be modified by further crosslinking the double bonds of the polydicyclopentadiene. This additional cross-linking reaction provides the “highly cross-linked polydicyclopentadiene membrane” which is used herein to separate molecules. Thus, the additional crosslinking is accomplished with another reagent (in addition to the ring-opening metathesis polymerization catalyst which is used to prepare the starting PDCPD). Accordingly, the “highly cross-linked polydicyclopentadiene membrane” has a higher level of crosslinking than the polydicyclopentadien material prepared from dicyclopentadiene using only a ring-opening metathesis polymerization catalyst. The additional crosslinking of the polydicyclopentadiene can be accomplished by any viable reaction that forms a covalent bond between the carbon atoms of two different carbon-carbon double bonds of the polydicyclopentadiene. Such cross-linking reactions include radical-based reactions which proceed by a radical initiator (e.g., a peroxide such as benzoyl peroxide) and cationic-based reactions which proceed by cation initiator (e.g., an iodonium salt such as PC-2506). Thus, the additional crosslinking is accomplished with another reagent (in addition to the ring-opening metathesis polymerization catalyst) which crosslinks the polydicyclopentadiene to a further extent than what is present in the starting polydicyclopentadiene

In one embodiment the polydicyclopentadiene (e.g., material from which the highly cross linked dicyclopentadiene is prepared) comprises 2 or more dicyclopentadiene residues. In one embodiment the polydicyclopentadiene (e.g., material from which the highly cross linked dicyclopentadiene is prepared) comprises 5 or more dicyclopentadiene residues. In one embodiment the polydicyclopentadiene (e.g., material from which the highly cross linked dicyclopentadiene is prepared) comprises 20 or more dicyclopentadiene residues. In one embodiment the polydicyclopentadiene (e.g., material from which the highly cross linked dicyclopentadiene is prepared) comprises 100 or more dicyclopentadiene residues. In one embodiment the polydicyclopentadiene (e.g., material from which the highly cross linked dicyclopentadiene is prepared) comprises 1000 or more dicyclopentadiene residues. In one embodiment the polydicyclopentadiene (e.g., material from which the highly cross linked dicyclopentadiene is prepared) comprises 10,000 or more dicyclopentadiene residues. In one embodiment the highly cross linked polydicyclopentadiene comprises 2 or more dicyclopentadiene residues. In one embodiment the highly cross linked polydicyclopentadiene comprises 5 or more dicyclopentadiene residues. In one embodiment the highly cross linked polydicyclopentadiene comprises 20 or more dicyclopentadiene residues. In one embodiment the highly cross linked polydicyclopentadiene comprises 100 or more dicyclopentadiene residues. In one embodiment the polydicyclopentadiene comprises 1000 or more dicyclopentadiene residues. In one embodiment the highly cross linked polydicyclopentadiene comprises 10,000 or more dicyclopentadiene residues.

The polydicyclopentadiene material can be prepared by any ring-opening metathesis catalyst including Grubbs catalyst (e.g., first and second generation) and Schrock catalysts. Non-limiting examples of ring-opening metathesis catalysts include: benzylidene-bis(tricyclohexylphosphine)dichlororuthenium; (1,3-bis(2,4,6-trimethylphenyl)-2-imidazolidinylidene)dichloro(phenylmethylene)-(tricyclohexylphosphine)ruthenium; benzylidene[1,3-bis(2,4,6-trimethylphenyl)-2-imidazolidinylidene]dichloro-(tricyclohexylphosphine)ruthenium; [1,3-bis-(2,4,6-trimethylphenyl)-2-imidazolidinylidene]dichloro(phenylmethylene)-(tricyclohexylphosphine)ruthenium; dichloro(o-isopropoxyphenylmethylene)(tricyclohexylphosphine)ruthenium(II); (1,3-bis-(2,4,6-trimethylphenyl)-2-imidazolidinylidene)dichloro(o-isopropoxyphenylmethylene)ruthenium; dichloro[1,3-bis(2-methylphenyl)-2-imidazolidinylidene](2-isopropoxyphenylmethylene)ruthenium(II); bis(tricyclohexylphosphine)isopentenylidene ruthenium dichloride; [2-(1-methylethoxy-O)phenylmethyl-C](nitrato-O,O′) {rel-(2R,5R,7R)-adamantane-2,1-diyl[3-(2,4,6-trimethylphenyl)-1-imidazolidinyl-2-ylidene]}ruthenium; dichloro[1,3-bis(2,6-isopropylphenyl)-2-imidazolidinylidene](2-isopropoxyphenylmethylene)ruthenium(II); dichloro[1,3-bis(2,6-isopropylphenyl)-2-imidazolidinylidene](benzylidene)-(tricyclohexylphosphine)ruthenium(II); [1,3-bis(2,4,6-trimethylphenyl)-2-imidazolidinylidene]dichloro(phenylmethylene)bis(3-bromopyridine)ruthenium(II); [1,3-Dimesityl-2imidazolidinylidene]-dichloro(phenylmethylene)bis(3-bromopyridine)ruthenium(II); [1,3-bis(2-methylphenyl)-2-imidazolidinylidene]dichloro(phenylmethylene) (tricyclohexylphosphine)ruthenium(II); isopentenylidene(1,3-dimesitylimidazolidin-2-ylidene) (tricyclohexylphosphine)ruthenium(II) dichloride; [SIMes]dichloro(3-methyl-2-butenylidene)(tricyclohexylphosphine)Ru(II); dichloro(3-methyl-2-butenylidene)bis(tricyclopentylphosphine)ruthenium(II); [1,3-dimesityl-2-imidazolidinylidene]dichloro[3-(2-pyridinyl)propylidene]ruthenium(II); and dichloro[1,3-bis(2,4,6-trimethylphenyl)-2-imidazolidinylidene][(tricyclohexylphosphoranyl)-methylidene]ruthenium(II)tetrafluoroborate.

In one embodiment the molar ratio of dicyclopentadiene (DCPD) to the crosslinking agent is less than or about equal to 500/1. In one embodiment the molar ratio of dicyclopentadiene (DCPD) to the crosslinking agent is less than or about equal to 1000/1. In one embodiment the molar ratio of dicyclopentadiene (DCPD) to the crosslinking agent is less than or about equal to 2000/1. In one embodiment the molar ratio of dicyclopentadiene (DCPD) to the crosslinking agent is less than or about equal to 3000/1. In one embodiment the molar ratio of dicyclopentadiene (DCPD) to the crosslinking agent is less than or about equal to 4000/1. In one embodiment the molar ratio of dicyclopentadiene (DCPD) to the crosslinking agent is less than or about equal to 5000/1. In one embodiment the molar ratio of dicyclopentadiene (DCPD) to the crosslinking agent is less than or about equal to 6000/1. In one embodiment the molar ratio of dicyclopentadiene (DCPD) to the crosslinking agent is less than or about equal to 7000/1. In one embodiment the molar ratio of dicyclopentadiene (DCPD) to the crosslinking agent is less than or about equal to 8000/1. In one embodiment the molar ratio of dicyclopentadiene (DCPD) to the crosslinking agent is less than or about equal to 9000/1. In one embodiment the molar ratio of dicyclopentadiene (DCPD) to the crosslinking agent is less than or about equal to 10,000/1. In one embodiment the molar ratio of dicyclopentadiene (DCPD) to the crosslinking agent is less than or about equal to 12,000/1.

In one embodiment the molar ratio of dicyclopentadiene (DCPD) to the crosslinking agent is less than or about equal to 14,000/1. In one embodiment the molar ratio of dicyclopentadiene (DCPD) to the crosslinking agent is greater than or about equal to 14,000/1.

In one embodiment the molar ratio of dicyclopentadiene (DCPD) to the crosslinking agent is about 500/1 to about 1000/1. In one embodiment the molar ratio of dicyclopentadiene (DCPD) to the crosslinking agent is about 1000/1 to about 3000/1. In one embodiment the molar ratio of dicyclopentadiene (DCPD) to the crosslinking agent is about 3000/1 to about 5000/1. In one embodiment the molar ratio of dicyclopentadiene (DCPD) to the crosslinking agent is about 5000/1 to about 7000/1. In one embodiment the molar ratio of dicyclopentadiene (DCPD) to the crosslinking agent is about 7000/1 to about 10,000/1. In one embodiment the molar ratio of dicyclopentadiene (DCPD) to the crosslinking agent is about 9000/1 to about12,000/1. In one embodiment the molar ratio of dicyclopentadiene (DCPD) to the crosslinking agent is about 10,000/1 to about 14,000/1.

Scheme 5 outlines one particular preparation of the highly cross-linked PDCPD membrane. An initial polydicyclopentadiene (PDCPD) membrane was prepared as described previously from dicyclopentadiene and a ring-opening metathesis catalyst such as Grubbs first generation catalyst. The PDCPD membrane was then swollen with solvent comprising benzoyl peroxide. The solvent was removed and the membrane was heated to allow the benzoyl peroxide to decompose into radicals that further cross-linked the PDCPD to provide the highly cross-linked PDCPD membrane.

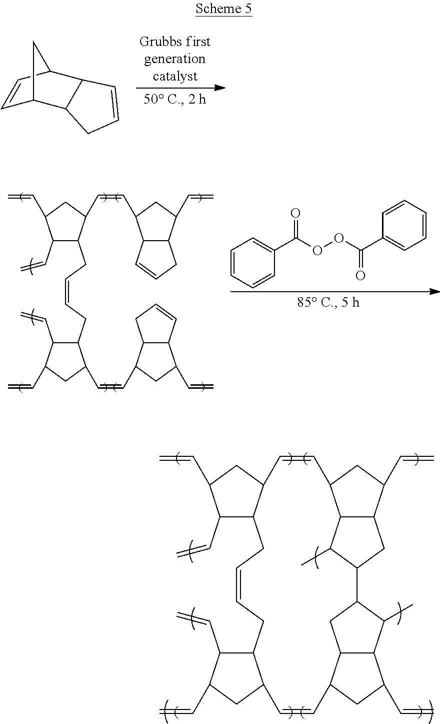

In one embodiment the polydicyclopentadiene membrane is prepared by the addition of a small amount of ring-opening polymerization catalyst such as Grubbs catalyst (e.g., first or second generation catalyst) to dicyclopentadiene. In one embodiment a molar ratio of 5,000/1 of dicyclopentadiene to Grubbs catalyst (e.g., first or second generation catalyst) is used to prepare a PDCPD membrane. The dicyclopentadiene is rapidly polymerized by the Grubbs catalyst to yield the polydicyclopentadiene which is then further crosslinked with a reagent capable of crosslinking two or more double bonds of polydicyclopentadiene. The highly cross-linked PDCPD membranes can also be prepared by methods that are different than the one described above. One such involves mixing dicyclopentadiene, a cross-linking reagent (e.g., a radical initiator such as benzoyl peroxide or a cation initiator such as PC-2506), and a ring-opening polymerization catalyst (e.g., Grubbs catalyst such as a first or second generation Grubbs catalyst) and optionally a solvent.

The highly crosslinked polydicyclopentadiene membranes used herein include membranes wherein the ratio of crosslinked double bonds to uncrosslinked double bonds in the highly crosslinked polydicyclopentadiene membrane is greater than the corresponding polydicyclopentadiene from which the highly crosslinked polydicyclopentadiene membrane was prepared.

The highly crosslinked polydicyclopentadiene membranes described herein can be a regular, irregular and/or random arrangement of polymer molecules such that on a macromolecular scale the arrangements of molecules may show repeating patterns, or may show series of patterns that sometimes repeat and sometimes display irregularities, or may show no pattern. On a scale such as would be obtained from TEM, SEM, X-Ray or FTNMR, the molecular arrangement may show a physical configuration in three dimensions like those of networks, meshes, arrays, frameworks, scaffoldings, three dimensional nets or three dimensional entanglements of molecules. The highly crosslinked polydicyclopentadiene membranes may be self-supporting or non-self-supporting. The highly crosslinked polydicyclopentadiene membranes are typically in the form of a thin film with an average thickness from about 10 nm to about 1,000,000 nm. The highly crosslinked polydicyclopentadiene membranes can be grossly configured as an ultrathin film or sheet.

The highly crosslinked polydicyclopentadiene membranes may be part of a composite membrane. In one embodiment the invention provides a composite membrane comprising a highly crosslinked polydicyclopentadiene membrane on porous support backing material. In one embodiment the invention provides a composite membrane comprising a highly crosslinked polydicyclopentadiene membrane in contact with a porous support backing material. The porous support backing material can comprise a polymeric material containing pore sizes which are of sufficient size to permit the passage of permeate there through. Examples of porous support backing materials which may be used to prepare composite membranes include polymers such as polysulfones, polycarbonates, microporous polypropylenes, polyamides, polyimines, polyphenylene ethers, and various halogenated polymers such as polyvinylidine fluoride. In addition, the membrane can rest on a metal mesh for solid support. In one embodiment the invention provides a composite membrane comprising a highly crosslinked polydicyclopentadiene membrane in contact with a metal mesh. In one embodiment the invention provides a composite membrane comprising a highly crosslinked polydicyclopentadiene on a metal mesh.

The highly crosslinked polydicyclopentadiene membranes can be of any shape (e.g., spiral wound membranes) and can also include a plurality of membranes (e.g., membranes of two or more layers).

The membranes including the highly crosslinked polydicyclopentadiene membranes can be characterized by the measuring the permeation of certain compounds. In one embodiment the membranes described herein are characterized in that stearic acid and oleic acid more readily flow through the membrane than linoleic acid. This difference allows for the separation of compounds including fatty acids, thereby resulting in the permeate being enriched in one or more compounds and/or the retentate being enriched in one or more compounds. In one embodiment the membrane is characterized in that when the membrane is contacted with a mixture comprising stearic acid, oleic acid and linoleic acid, the mixture is fractionated into a permeate and a retentate wherein the retentate is enriched in linoleic acid. In one embodiment the membrane is characterized in that when the membrane is contacted with a mixture comprising stearic acid and linoleic acid, the mixture is fractionated into a permeate and a retentate wherein the retentate is enriched in linoleic acid. In one embodiment the membrane is characterized in that when the membrane is contacted with a mixture comprising oleic acid and linoleic acid, the mixture is fractionated into a permeate and a retentate wherein the retentate is enriched in linoleic acid. In one embodiment the membrane is characterized in that when the membrane is contacted with a mixture comprising triethylamine and triisobutylamine, the mixture is fractionated into a permeate and a retentate wherein the retentate is enriched in triisobutylamine. In one embodiment the membrane is characterized in that when the membrane is contacted with a mixture comprising triethylamine and triisobutylamine, the mixture is fractionated into a permeate and a retentate wherein the permeate is enriched in triethylamine. The characterization can be measured by the methods discussed herein. In one embodiment the membranes including the highly crosslinked polydicyclopentadiene membranes described herein can be characterized by the measuring the permeation of certain compounds as described in the above embodiments using the method described in the Permeation Studies section of Example 1 herein below.

### Fatty Acids

The term “fatty acid” as used herein refers to an aliphatic carboxylic acid. The aliphatic group of the fatty acid is a hydrocarbon chain of about 4-28 carbons and can be straight, branched, saturated or unsaturated (e.g., comprising one or more carbon-carbon double bonds). Fatty acids include saturated fatty acids (e.g., fatty acids wherein the aliphatic group is saturated, for example (C₄-C₂₈)alkyl) such as (C₄-C₂₈)alkylCO₂H and unsaturated fatty acids (e.g. fatty acids wherein the aliphatic group has one or more one carbon-carbon double bonds, for example (C₄-C₂₈)alkenyl) such as (C₄-C₂₈)alkenylCO₂H. Unsaturated fatty acids include monounsaturated fatty acids (fatty acids wherein the aliphatic group has one carbon-carbon double) and polyunsaturated fatty acids (fatty acids wherein the aliphatic group has two or more carbon-carbon double bonds).

Fatty acids include but are not limited to oleic acid, linoleic, linolenic acid, vaccenic acid, petroselinic acid, elaidic acid, palmitic acid, stearic acid, omega 3 fatty acids (e.g., linolenic acid, eicosapentaenoic acid and docosahexaenoic acid), omega 6 fatty acids (e.g., linoleic acid and arachidonic acid) and omega 9 fatty acids (e.g., oleic acid).

The term “cis-fatty acid” refers to an unsaturated fatty acid that has at least one cis carbon-carbon double bond in the aliphatic group (e.g., cis-(C₄-C₂₈)alkenylCO₂H). Examples of cis-fatty acids include but are not limited to oleic acid, linoleic acid, linolenic acid, vaccenic acid, petroselinic acid, eicosapentaenoic acid, docosahexaenoic acid and arachidonic acid.

The term “trans-fatty acid” refers to an unsaturated fatty acid that has at least one trans carbon-carbon double bond and no cis carbon-carbon double bonds in the aliphatic group (e.g., trans-(C₄-C₂₈)alkenylCO₂H). Examples of trans-fatty acids include but are not limited to elaidic acid.

### Fatty Acid Esters

The term “fatty acid ester” as used herein refers to a fatty acid as described above wherein the acid group is an ester. Some fatty acids esters are described as monoglycerides. In one embodiment the fatty acid ester is (C₄-C₂₈)alkylCO₂R or (C₄-C₂₈)alkenylCO₂R wherein R is a (C₁-C₁₈)alkyl, (C₁-C₁₈)heteroalkyl, (C₁-C₁₈)alkenyl) or (C₁-C₁₈)heteroalkenyl. In one embodiment R is a (C₁-C₆)alkyl. In one embodiment R is a methyl or ethyl.

Fatty acid esters include but are not limited to esters of oleic acid, linolenic acid, vaccenic acid, petroselinic acid, elaidic acid, palmitic acid, stearic acid, omega 3 fatty acids (e.g. linolenic acid, eicosapetnaenoic acid and docosahexaenoic acid), omega 6 fatty acids (e.g. linoleic acid and arachidonic acid) and omega 9 fatty acids.

The term “cis-fatty acid ester” refers to a cis-fatty acid as described above wherein the acid group is an ester. In one embodiment the cis-fatty acid ester is (C₄-C₂₈)alkenylCO₂R wherein R is a (C₁-C₁₈)alkyl, (C₁-C₁₈)heteroalkyl, (C₁-C₁₈)alkenyl) or (C₁-C₁₈)heteroalkenyl. In one embodiment R is a (C₁-C₆)alkyl. In one embodiment R is a methyl or ethyl. Examples of cis-fatty acid esters include but are not limited to esters of oleic acid, linoleic acid, linolenic acid, vaccenic acid, petroselinic acid, eicosapentaenoic acid, docosahexaenoic acid and arachidonic acid.

The term “trans-fatty acid ester” refers to a trans-fatty acid as described above wherein the acid group is an ester. In one embodiment the trans-fatty acid ester is (C₄-C₂₈)alkenylCO₂R wherein R is a (C₁-C₁₈)alkyl, (C₁-C₁₈)heteroalkyl, (C₁-C₁₈)alkenyl) or (C₁-C₁₈)heteroalkenyl. In one embodiment R is a (C₁-C₆)alkyl. In one embodiment R is a methyl or ethyl. Examples of trans-fatty acid—include but are not limited to elaidic acid.

### Radical Initiator

As used herein the term “radical initiator” includes any reagent that induces bond formation (e.g., covalent bond formation) between two carbon-carbon double bonds (such as the carbon-carbon double bonds of polydicyclopentadiene) and that proceeds through a radical intermediate. The resulting bond is generally between one carbon atom of a carbon-carbon double bond and another carbon atom of a different carbon-carbon double bond. Many such reagents are known and include reagents that are used in radical-based polymerization reactions. One particular type of radical initiator is a peroxide radical initiator such as benzoyl peroxide.

A radical initiator is a molecule that after irradiation with light, upon heating, or after a different event will yield free radicals. Type I radical initiators breaks into two or more free radicals and Type II radical initiators have one molecule that absorbs energy and then interacts with a second molecule to generate free radicals. Free radicals are small molecules with one (sometimes two) unpaired electron on an atom or functional group. Some radical initiators will absorb energy of the right type and yield only one free radical. Free radicals are highly reactive and can react with carbon-carbon double bonds to form a new bond and a carbon-based radical on the carbon atom of the double bond. These free radicals are typically short-lived and highly reactive.

### Cation Initiator

As used herein the term “cation initiator” includes any reagent that induces bond formation (e.g., covalent bond formation) between two carbon-carbon double bonds (such as the carbon-carbon double bonds of polydicyclopentadiene) and that proceeds through a cation intermediate. The resulting bond is generally between one carbon atom of a carbon-carbon double bond and another carbon atom of a different carbon-carbon double bond. Many such reagents are known and include reagents that are used in cation-based polymerization reactions. Particular types of cation initiators include iodonuim (e.g., diaryliodonium) and sulfonium (e.g., triarylsulfonium) cationic initiators (e.g., catalyst such as diphenyliodonium-SF₆ based catalyst (i.e., PC-2506 offered by Polyset Inc)).

A cation initiator is a small molecule that after irradiation with light, upon heating, or after a different event will yield one or more carbocations or other positively charged atoms or functional groups such as protons. Cation initiators are sometimes referred to as cationic initiators. Type I cation initiators absorb energy and break into one or more cations. Type II cation initiators have one molecule which absorbs energy and then transfers it to a second molecule to generate cations. Cation initiators are also include strong Lewis or Bronsted-Lowry acids that react to yield carbocations. Carbocations are positively charged carbon atoms and are highly reactive with carbon-carbon double bonds. Cations are a general term for an atom, molecule, or functional group that is positively charged.

### Salts

The fatty acids discussed herein include salts of the fatty acids and these salts can be separated. In one embodiment the salts include alkali metals and alkaline earth metals. In one embodiment the salts include lithium, sodium, potassium, cesium, silver, calcium and magnesium salts. In one embodiment the fatty acids do not include salts of the fatty acids (e.g., non-salt fatty acids).

In one embodiment the salts do not include positively charged amine salts.

In another embodiment the salts do not include (1) amines such as mono, di, tri and tetrasubstituted amines wherein the substituents are independently selected from optionally substituted alkyl, optionally substituted alkenyl, optionally substituted alkynyl and optionally substituted cycloalkyl groups, and (2) cyclic amines and cyclic amines wherein cyclic amine refers to a cycloalkyl wherein one or more (e.g., 1, 2 or 3) of the carbon atoms of the cycloalkyl have be replaced with one or more nitrogen atoms and wherein one or more of the carbon atoms (e.g., 1 or 2) have been optionally replaced with a heteroatom selected from oxygen and sulfur. In another embodiment the salts do not include azetidinyl, pyrrolidinyl, morpholinyl, thiomorpholinyl, piperazinyl, homopiperazinyl and piperidinyl. The term “optionally substituted cyclic amine” includes cyclic amines that are optionally substituted with one or more (e.g., 1, 2, 3, 4, 5, or more) groups independently selected from (C₁-C₆)alkyl, (C₂-C₆)alkenyl, (C₂-C₆)alkynyl, oxo (═O), halo, —OR^{a}, —NR^{a}₂ and —NR^{a}₃ wherein each R^{a} is independently selected from H, (C₁-C₆)alkyl, (C₂-C₆)alkenyl, (C₂-C₆)alkynyl and (C₃-C₇)cycloalkyl).

In another embodiment the salts do not include positively charged amines including those amines described in paragraph above that are positively charged and included tetrasubstituted amines including tetrasubstituted cyclic amines and protonated amines (e.g. amines (including cyclic amines) that are positively charged and have at least one hydrogen on the amine nitrogen).

In one embodiment the salts include positively charged amine salts.

In another embodiment the salts include (1) amines such as mono, di, tri and tetrasubstituted amines wherein the substituents are independently selected from optionally substituted alkyl, optionally substituted alkenyl, optionally substituted alkynyl and optionally substituted cycloalkyl groups, and (2) cyclic amines and cyclic amines wherein cyclic amine refers to a cycloalkyl wherein one or more (e.g., 1, 2 or 3) of the carbon atoms of the cycloalkyl have be replaced with one or more nitrogen atoms and wherein one or more of the carbon atoms (e.g,. 1 or 2) have been optionally replaced with a heteroatom selected from oxygen and sulfur. In another embodiment the salts do not include azetidinyl, pyrrolidinyl, morpholinyl, thiomorpholinyl, piperazinyl, homopiperazinyl and piperidinyl. The term “optionally substituted cyclic amine” includes cyclic amines that are optionally substituted with one or more (e.g., 1, 2, 3, 4, 5, or more) groups independently selected from (C₁-C₆)alkyl, (C₂-C₆)alkenyl, (C₂-C₆)alkynyl, oxo (═O), halo, —OR^{a}, —NR^{a}₂ and —NR^{a}₃ wherein each R^{a} is independently selected from H, (C₁-C₆)alkyl, (C₂-C₆)alkenyl, (C₂-C₆)alkynyl and (C₃-C₇)cycloalkyl).

In another embodiment the salts include positively charged amines including those amines described in paragraph above that are positively charged and included tetrasubstituted amines including tetrasubstituted cyclic amines and protonated amines (e.g. amines (including cyclic amines) that are positively charged and have at least one hydrogen on the amine nitrogen).

### Solvents

Any suitable organic solvent can be used in the separation of the compounds (e.g., molecules) fatty acids, or fatty acid esters described herein. For example, suitable solvents may include protic and aprotic organic solvents (e.g. methanol, benzene, toluene, methylene chloride, chloroform, carbontetrachloride, tetrahydrofuran, pentane, hexanes, dimethylformamide or acetonitrile) or mixtures thereof. In some separations, no solvent is needed because the compounds, fatty acids, or fatty acid esters are their own solvents. Accordingly, one embodiment provides for the separation of one or more compounds, fatty acids, or fatty acid esters, as described herein, in the absence of any additional solvent.

### Embodiments

It is to be understood that the following embodiments can be combined with one or more additional embodiments as described herein. It is also to be understood that when the embodiments are directed to membranes and composite membranes such embodiments are also directed to membranes and composite membranes that are used in the methods of the invention.

In one embodiment the membrane is characterized in that when the membrane is contacted by a mixture of steric acid, linoleic acid and linoleic acid, the mixture is fractionated into a permeate and a retentate wherein the retentate is enhanced in linoleic acid.

In one embodiment the membrane is an organic solvent nanofiltration membrane.

In one embodiment the organic solvent nanofiltration membrane comprises polydicyclopentadiene, polyimide, polyaniline or polyacrylate.

In one embodiment the organic solvent nanofiltration membrane comprises highly crosslinked polydicyclopentadiene, polyimide, polyaniline or polyacrylate.

In one embodiment the organic solvent nanofiltration membrane comprises polydicyclopentadiene.

In one embodiment the organic solvent nanofiltration membrane comprises a highly crosslinked polydicyclopentadiene.

In one embodiment the highly crosslinked polydicyclopentadiene is obtainable by contacting polydicyclopentadiene with a reagent to crosslink two or more double bonds of the polydicyclopentadiene.

In one embodiment the highly crosslinked polydicyclopentadiene is obtained from polydicyclopentadiene by contacting the polydicyclopentadiene with a reagent to crosslink two or more double bonds of the polydicyclopentadiene.

In one embodiment the reagent crosslinks the double bonds of the polydicyclopentadiene through a radical intermediate or through a cation intermediate.

In one embodiment the reagent which crosslinks the double bonds of the polydicyclopentadiene is a radical initiator or a cationic initiator.

In one embodiment the reagent which crosslinks the double bonds of the polydicyclopentadiene is a radical initiator.

In one embodiment the reagent which crosslinks the double bonds of the polydicyclopentadiene is a peroxide.

In one embodiment the reagent which crosslinks the double bonds of the polydicyclopentadiene is benzoyl peroxide or diphenyliodonium-SbF₆.

In one embodiment the polydicyclopentadiene is obtained from dicyclopentadiene through ring-opening metathesis polymerization.

In one embodiment the polydicyclopentadiene is obtained from dicyclopentadiene by treating the dicyclopentadiene with a ring-opening metathesis polymerization catalyst.

In one embodiment the ring-opening metathesis polymerization catalyst is a Grubbs catalyst.

In one embodiment the membrane is a part of an assembly that comprises two or more membranes.

In one embodiment the membrane is part of a spiral wound module.

In one embodiment the membrane separates the fatty acids or fatty acid esters based on their cross-sectional areas.

In one embodiment the permeate is enriched in one or more different fatty acids or one or more different fatty acid esters.

In one embodiment the retentate is enriched in one or more different fatty acids or one or more different fatty acid esters.

In one embodiment the permeate is enriched in one or more different fatty acids and the retentate is enriched in one or more different fatty acids or the permeate is enriched in one or more different fatty acid esters and the retentate is enriched in one or more different fatty acid esters.

In one embodiment the mixture comprises two or more different fatty acids.

In one embodiment the permeate is enriched in one or more different fatty acids.

In one embodiment the retentate is enriched in one or more different fatty acids.

In one embodiment the permeate is enriched in one or more different fatty acid acids and the retentate is enriched in one or more different fatty acids.

In one embodiment the mixture comprises two or more different fatty acid esters.

In one embodiment the permeate is enriched in one or more different fatty acid esters.

In one embodiment the retentate is enriched in one or more different fatty acid esters.

In one embodiment the permeate is enriched in one or more different fatty acid esters and the retentate is enriched in one or more different fatty acid esters.

In one embodiment the mixture comprises at least one cis-fatty acid and at least one saturated fatty acid or at least one cis-fatty acid ester and at least one saturated fatty acid ester.

In one embodiment the mixture comprises two or more different cis-fatty acids or two or more cis-fatty acid esters.

In one embodiment the mixture comprises stearic acid, oleic acid and linoleic acid.

In one embodiment the mixture comprises the methyl esters of stearic acid, linolenic acid, oleic acid and linoleic acid.

In one embodiment the mixture comprises two or more different cis-fatty acids.

In one embodiment the permeate is enriched in one or more different cis-fatty acids.

In one embodiment the retentate is enriched in one or more different cis-fatty acids.

In one embodiment the permeate is enriched in one or more different cis-fatty acids and the retentate is enriched in one or more different cis-fatty acids.

In one embodiment the mixture comprises two or more different cis-fatty acid esters.

In one embodiment the permeate is enriched in one or more different cis-fatty acid esters.

In one embodiment the retentate is enriched in one or more different cis-fatty acid esters.

In one embodiment the permeate is enriched in one or more different cis-fatty acid esters and the retentate is enriched in one or more different cis-fatty acid esters.

In one embodiment the mixture comprises at least one cis-fatty acid and at least one saturated fatty acid.

In one embodiment the permeate is enriched in at least one saturated fatty acid.

In one embodiment the retentate is enriched in at least one cis-fatty acid.

In one embodiment he permeate is enriched in at least one saturated fatty acid and the retentate is enriched at least one cis-fatty acid.

In one embodiment the mixture comprises at least one cis-fatty acid ester and at least one saturated fatty acid ester.

In one embodiment the permeate is enriched in at least one saturated fatty acid ester.

In one embodiment the retentate is enriched in at least one cis-fatty acid ester.

In one embodiment the permeate is enriched in at least one saturated fatty acid ester and the retentate is enriched at least one cis-fatty acid ester.

In one embodiment the mixture comprises stearic acid, oleic acid and linoleic acid.

In one embodiment the mixture comprises the methyl esters of stearic acid, linolenic acid, oleic acid and linoleic acid.

In one embodiment the method of separation results in an enriched amount of oleic acid, linoleic acid, linolenic acid, EPA or DHA.

In one embodiment the method of separation results in an enriched amount of oleic acid ester, linoleic acid ester, linolenic acid ester, EPA ester or DHA ester.

In one embodiment the permeate is removed one or more times during the separation.

In one embodiment the permeate is removed one or more times during the separation and replaced with a solvent.

In one embodiment the permeate is removed continuously.

In one embodiment the mixture comprises a solvent.

In one embodiment the solvent comprises one or more protic or aprotic organic solvents.

In one embodiment the solvent comprises toluene, hexane, methanol or methylene chloride or mixtures thereof.

In one embodiment the solvent comprises methanol and methylene chloride.

In one embodiment the solvent comprises methylene chloride.

In one embodiment the mixture does not include any additional solvent.

In one embodiment pressure is applied to the mixture to increase the flux of the mixture through the membrane.

In one embodiment oleic acid is separated by any of the methods described herein.

In one embodiment linoleic acid is separated by any of the methods described herein.

In one embodiment linolenic acid is separated by any of the methods described herein.

In one embodiment EPA is separated by any of the methods described herein.

In one embodiment DHA is separated by any of the methods described herein.

In one embodiment oleic acid ester is separated by any of the methods described herein.

In one embodiment linoleic acid ester is separated by any of the methods described herein.

In one embodiment linolenic acid ester is separated by any of the methods described herein.

In one embodiment EPA ester is separated by any of the methods described herein.

In one embodiment DHA ester is separated by any of the methods described herein.

One embodiment provides a highly crosslinked polydicyclopentadiene composite membrane wherein the highly crosslinked polydicyclopentadiene membrane is in contact with a porous support backing material and wherein the highly crosslinked polydicyclopentadiene membrane is obtainable by contacting a polydicyclopentadiene with a reagent to crosslink two or more double bonds of the polydicyclopentadiene.

In one embodiment the highly crosslinked polydicyclopentadiene composite membrane is obtained by contacting a polydicyclopentadiene with a reagent to crosslink two or more double bonds of the polydicyclopentadiene.

In one embodiment the polydicyclopentadiene (of the highly crosslinked polydicyclopentadiene composite membrane) is obtainable from dicyclopentadiene through ring-opening metathesis polymerization.

In one embodiment the polydicyclopentadiene (of the highly crosslinked polydicyclopentadiene composite membrane) is obtained from dicyclopentadiene through ring-opening metathesis polymerization.

In one embodiment the polydicyclopentadiene (of the highly crosslinked polydicyclopentadiene composite membrane) is obtainable from dicyclopentadiene by treating the dicyclopentadiene with a ring-opening metathesis polymerization catalyst.

In one embodiment the polydicyclopentadiene (of the highly crosslinked polydicyclopentadiene composite membrane) is obtained from dicyclopentadiene by treating the dicyclopentadiene with a ring-opening metathesis polymerization catalyst.

In one embodiment the ring-opening metathesis polymerization catalyst is a Grubb's catalyst.

In one embodiment the reagent which crosslinks the double bonds through a radical intermediate or through a cation intermediate.

In one embodiment the reagent which crosslinks the double bonds is a radical initiator or a cation initiator.

In one embodiment the reagent which crosslinks the double bonds is a radical initiator.

In one embodiment the reagent which crosslinks the double bonds is a peroxide.

In one embodiment the reagent which crosslinks the double bonds is benzoyl peroxide or diphenyliodonium-SbF₆.

In one embodiment the highly crosslinked polydicyclopentadiene composite membrane is characterized in that when the highly crosslinked polydicyclopentadiene composite membrane is contacted by a mixture of steric acid, linoleic acid and linoleic acid, the mixture is fractionated into a permeate and a retentate wherein the retentate is enhanced in linoleic acid.

In one embodiment the porous support backing material is a polymeric material.

In one embodiment the polymeric material is a polysulfone, polycarbonate, polypropylene, polyamide, polyimine, polyphenylene ether or a halogenated polymer or a mixture thereof.

In one embodiment the highly crosslinked polydicyclopentadiene membrane comprises two or more highly crosslinked polydicyclopentadiene membranes.

In one embodiment the composite membrane is part of a spiral wound module.

In one embodiment the highly crosslinked polydicyclopentadiene membrane is part of a spiral wound module.

In one embodiment the porous support backing material is a metal mesh.

One embodiment provides a highly crosslinked polydicyclopentadiene membrane wherein the highly crosslinked polydicyclopentadiene membrane is obtainable by contacting a polydicyclopentadiene with a reagent to crosslink two or more double bonds of the polydicyclopentadiene.

In one embodiment the highly crosslinked polydicyclopentadiene membrane is obtained by contacting a polydicyclopentadiene with a reagent to crosslink two or more double bonds of the polydicyclopentadiene.

In one embodiment the polydicyclopentadiene (of the highly crosslinked polydicyclopentadiene membrane) is obtainable from dicyclopentadiene through ring-opening metathesis polymerization.

In one embodiment the polydicyclopentadiene (of the highly crosslinked polydicyclopentadiene membrane) is obtained from dicyclopentadiene through ring-opening metathesis polymerization.

In one embodiment the polydicyclopentadiene (of the highly crosslinked polydicyclopentadiene membrane) is obtainable from dicyclopentadiene by treating the dicyclopentadiene with a ring-opening metathesis polymerization catalyst.

In one embodiment the polydicyclopentadiene (of the highly crosslinked polydicyclopentadiene membrane) is obtained from dicyclopentadiene by treating the dicyclopentadiene with a ring-opening metathesis polymerization catalyst.

In one embodiment the ring-opening metathesis polymerization catalyst is a Grubbs catalyst.

In one embodiment the reagent which crosslinks the double bonds through a radical intermediate or through a cation intermediate.

In one embodiment the reagent which crosslinks the double bonds is a radical initiator or a cation initiator.

In one embodiment the reagent which crosslinks the double bonds is a radical initiator.

In one embodiment the reagent which crosslinks the double bonds is a peroxide.

In one embodiment the reagent which crosslinks the double bonds is benzoyl peroxide or diphenyliodonium-SbF₆.

In one embodiment the highly crosslinked polydicyclopentadiene membrane is obtained by (a) contacting polydicyclopentadiene with a reagent capable of crosslinking two or more double bonds of the polydicyclopentadiene or (b) contacting dicyclopentadiene with a ring-opening polymerization catalyst and a reagent capable of crosslinking two or more double bonds of polydicyclopentadiene.

In one embodiment the membrane is characterized in that when the membrane is contacted with a mixture comprising stearic acid, oleic acid and linoleic acid, the mixture is fractionated into a permeate and a retentate wherein the retentate is enriched in linoleic acid.

In one embodiment the highly crosslinked polydicyclopentadiene membrane is characterized in that when the membrane is contacted with a mixture comprising stearic acid, oleic acid and linoleic acid, the mixture is fractionated into a permeate and a retentate wherein the retentate is enriched in linoleic acid.

In one embodiment the organic solvent nanofiltration membrane comprises polydicyclopentadiene, highly crosslinked polydicyclopentadiene, polyimide, polyaniline or polyacrylate.

In one embodiment the organic solvent nanofiltration membrane comprises polydicyclopentadiene, highly crosslinked polydicyclopentadiene, polyimide, polyaniline or polyacrylate or mixtures thereof.

In one embodiment the highly crosslinked polydicyclopentadiene is obtainable by contacting polydicyclopentadiene with a reagent capable of crosslinking two or more double bonds of the polydicyclopentadiene.

In one embodiment the highly crosslinked polydicyclopentadiene is obtained by contacting polydicyclopentadiene with a reagent capable of crosslinking two or more double bonds of the polydicyclopentadiene.

In one embodiment the highly crosslinked polydicyclopentadiene is obtainable by contacting dicyclopentadiene with a ring-opening polymerization catalyst and a reagent capable of crosslinking two or more double bonds of polydicyclopentadiene.

In one embodiment the highly crosslinked polydicyclopentadiene is obtained by contacting dicyclopentadiene with a ring-opening polymerization catalyst and a reagent capable of crosslinking two or more double bonds of polydicyclopentadiene.

In one embodiment the reagent capable of crosslinking two or more double bonds of polydicyclopentadiene is not a Grubbs catalyst.

In one embodiment the reagent capable of crosslinking two or more double bonds of polydicyclopentadiene is not a ring-opening polymerization catalyst.

In one embodiment the reagent crosslinks the double bonds of polydicyclopentadiene through a radical intermediate or through a cation intermediate.

In one embodiment the reagent which crosslinks the double bonds of polydicyclopentadiene is a radical initiator or a cation initiator.

In one embodiment the reagent which crosslinks the double bonds of polydicyclopentadiene is a radical initiator.

In one embodiment the reagent which crosslinks the double bonds of polydicyclopentadiene is a peroxide.

In one embodiment the reagent which crosslinks the double bonds of polydicyclopentadiene is benzoyl peroxide or diphenyliodonium-SbF₆.

In one embodiment the reagent which crosslinks the double bonds of polydicyclopentadiene is a photoinitiator.

In one embodiment the reagent which crosslinks the double bonds of polydicyclopentadiene is a cationic photoinitiator.

In one embodiment the reagent which crosslinks the double bonds of polydicyclopentadiene is a diaryliodonium salt.

In one embodiment the reagent which crosslinks the double bonds of polydicyclopentadiene is PC 2506.

In one embodiment the polydicyclopentadiene is obtainable from dicyclopentadiene through ring-opening metathesis polymerization.

In one embodiment the polydicyclopentadiene is obtained from dicyclopentadiene by treating the dicyclopentadiene with a ring-opening metathesis polymerization catalyst.

In one embodiment the ring-opening metathesis polymerization catalyst is a Grubbs catalyst.

In one embodiment the membrane is a part of an assembly that comprises two or more membranes.

In one embodiment the membrane is part of a spiral wound module.

In one embodiment the membrane separates the mixture of two or more different compounds based on their critical areas.

In one embodiment the mixture of two or more different compounds comprises one or more compounds with critical areas of less than about 0.50 nm² and the mixture is fractionated into a permeate and a retentate, wherein the permeate is enriched in one or more the compounds with critical areas of less than about 0.50 nm².

In one embodiment the mixture of two or more different compounds comprises one or more compounds with critical areas of less than about 0.60 nm² and the mixture is fractionated into a permeate and a retentate, wherein the permeate is enriched in one or more the compounds with critical areas of less than about 0.60 nm².

In one embodiment the mixture of two or more different compounds comprises one or more compounds with critical areas of less than about 0.45 nm² and the mixture is fractionated into a permeate and a retentate, wherein the permeate is enriched in one or more the compounds with critical areas of less than about 0.45 nm².

In one embodiment the mixture of two or more different compounds comprises one or more compounds with critical areas of less than about 0.40 nm² and the mixture is fractionated into a permeate and a retentate, wherein the permeate is enriched in one or more the compounds with critical areas of less than about 0.40 nm².

In one embodiment the mixture of two or more different compounds comprises one or more compounds with critical areas of less than about 0.35 nm² and the mixture is fractionated into a permeate and a retentate, wherein the permeate is enriched in one or more the compounds with critical areas of less than about 0.35 nm².

In one embodiment the mixture of two or more different compounds comprises one or more compounds with critical areas of less than about 0.30 nm² and the mixture is fractionated into a permeate and a retentate, wherein the permeate is enriched in one or more the compounds with critical areas of less than about 0.30 nm².

In one embodiment the permeate is enriched in one or more of the compounds.

In one embodiment the retentate is enriched in one or more of the compounds.

In one embodiment the permeate is enriched in one or more of the compounds and the retentate is enriched in one or more of the compounds.

In one embodiment the mixture of two or more different compounds is (a) a mixture of two or more different fatty acids wherein the mixture is fractionated into a permeate and a retentate, wherein the permeate or retentate is enriched in one or more of the fatty acids or (b) a mixture of two or more different fatty acid esters wherein the mixture is fractionated into a permeate and a retentate, wherein the permeate or retentate is enriched in one or more of the fatty acid esters.

In one embodiment the membrane separates the fatty acids or fatty acid esters based on their critical areas.

In one embodiment the mixture of two or more different fatty acids comprises one or more fatty acids with critical areas of less than about 0.50 nm², and the mixture is fractionated into a permeate and a retentate, wherein the permeate is enriched in one or more of the fatty acids with critical areas of less than about 0.50 nm².

In one embodiment the mixture of two or more different fatty acids comprises one or more fatty acids with critical areas of less than about 0.60 nm², and the mixture is fractionated into a permeate and a retentate, wherein the permeate is enriched in one or more of the fatty acids with critical areas of less than about 0.60 nm².

In one embodiment the mixture of two or more different fatty acids comprises one or more fatty acids with critical areas of less than about 0.45 nm², and the mixture is fractionated into a permeate and a retentate, wherein the permeate is enriched in one or more of the fatty acids with critical areas of less than about 0.45 nm².

In one embodiment the mixture of two or more different fatty acids comprises one or more fatty acids with critical areas of less than about 0.40 nm², and the mixture is fractionated into a permeate and a retentate, wherein the permeate is enriched in one or more of the fatty acids with critical areas of less than about 0.40 nm².

In one embodiment the mixture of two or more different fatty acids comprises one or more fatty acids with critical areas of less than about 0.35 nm², and the mixture is fractionated into a permeate and a retentate, wherein the permeate is enriched in one or more of the fatty acids with critical areas of less than about 0.35 nm².

In one embodiment the mixture of two or more different fatty acids comprises one or more fatty acids with critical areas of less than about 0.30 nm², and the mixture is fractionated into a permeate and a retentate, wherein the permeate is enriched in one or more of the fatty acids with critical areas of less than about 0.30 nm².

In one embodiment the mixture of two or more different fatty acid esters comprises one or more fatty acid esters with cross-sectional areas of less than about 0.50 nm², and the mixture is fractionated into a permeate and a retentate, wherein the permeate is enriched in one or more of the fatty acid esters with cross-sectional areas of less than about 0.50 nm².

In one embodiment the mixture of two or more different fatty acid esters comprises one or more fatty acid esters with cross-sectional areas of less than about 0.60 nm², and the mixture is fractionated into a permeate and a retentate, wherein the permeate is enriched in one or more of the fatty acid esters with cross-sectional areas of less than about 0.60 nm².

In one embodiment the mixture of two or more different fatty acid esters comprises one or more fatty acid esters with cross-sectional areas of less than about 0.45 nm², and the mixture is fractionated into a permeate and a retentate, wherein the permeate is enriched in one or more of the fatty acid esters with cross-sectional areas of less than about 0.45 nm².

In one embodiment the mixture of two or more different fatty acid esters comprises one or more fatty acid esters with cross-sectional areas of less than about 0.40 nm², and the mixture is fractionated into a permeate and a retentate, wherein the permeate is enriched in one or more of the fatty acid esters with cross-sectional areas of less than about 0.40 nm².

In one embodiment the mixture of two or more different fatty acid esters comprises one or more fatty acid esters with cross-sectional areas of less than about 0.35 nm², and the mixture is fractionated into a permeate and a retentate, wherein the permeate is enriched in one or more of the fatty acid esters with cross-sectional areas of less than about 0.35 nm².

In one embodiment the mixture of two or more different fatty acid esters comprises one or more fatty acid esters with cross-sectional areas of less than about 0.30 nm², and the mixture is fractionated into a permeate and a retentate, wherein the permeate is enriched in one or more of the fatty acid esters with cross-sectional areas of less than about 0.30 nm².

In one embodiment the permeate is enriched in one or more of the fatty acids or one or more of the fatty acid esters.

In one embodiment the retentate is enriched in one or more of the fatty acids or one or more of the fatty acid esters.

In one embodiment the permeate is enriched in one or more of the fatty acids and the retentate is enriched in one or more of the fatty acids or the permeate is enriched in one or more of the fatty acid esters and the retentate is enriched in one or more of the fatty acid esters.

In one embodiment the method comprises contacting the membrane with a mixture of two or more different fatty acids, so that the mixture is fractionated into a permeate and a retentate, wherein the permeate or retentate is enriched in one or more of the fatty acids.

In one embodiment the permeate is enriched in one or more of the fatty acids.

In one embodiment the retentate is enriched in one or more of the fatty acids.

In one embodiment the permeate is enriched in one or more of the fatty acid acids and the retentate is enriched in one or more of the fatty acids.

In one embodiment the method comprises contacting a membrane with a mixture of two or more different fatty acid esters, so that the mixture is fractionated into a permeate and a retentate, wherein the permeate or retentate is enriched in one or more of the fatty acid esters.

In one embodiment the permeate is enriched in one or more different fatty acid esters.

In one embodiment the retentate is enriched in one or more different fatty acid esters.

In one embodiment the permeate is enriched in one or more of the fatty acid esters and the retentate is enriched in one or more of the fatty acid esters.

In one embodiment the mixture comprises at least one cis-fatty acid and at least one saturated fatty acid or at least one cis-fatty acid ester and at least one saturated fatty acid ester.

In one embodiment the mixture comprises two or more different cis-fatty acids or two or more cis-fatty acid esters.

In one embodiment the mixture comprises stearic acid, oleic acid and linoleic acid.

In one embodiment the mixture comprises the methyl esters of stearic acid, linolenic acid, oleic acid and linoleic acid.

In one embodiment the mixture comprises two or more different cis-fatty acids.

In one embodiment the permeate is enriched in one or more different cis-fatty acids.

In one embodiment the retentate is enriched in one or more different cis-fatty acids.

In one embodiment the permeate is enriched in one or more different cis-fatty acids and the retentate is enriched in one or more different cis-fatty acids.

In one embodiment the mixture comprises two or more different cis-fatty acid esters.

In one embodiment the permeate is enriched in one or more different cis-fatty acid esters.

In one embodiment the retentate is enriched in one or more different cis-fatty acid esters.

In one embodiment the permeate is enriched in one or more different cis-fatty acid esters and the retentate is enriched in one or more different cis-fatty acid esters.

In one embodiment the mixture comprises at least one cis-fatty acid and at least one saturated fatty acid.

In one embodiment the permeate is enriched in at least one saturated fatty acid.

In one embodiment the retentate is enriched in at least one cis-fatty acid.

In one embodiment the permeate is enriched in at least one saturated fatty acid and the retentate is enriched in at least one cis-fatty acid.

In one embodiment the mixture comprises at least one cis-fatty acid ester and at least one saturated fatty acid ester.

In one embodiment the permeate is enriched in at least one saturated fatty acid ester.

In one embodiment the retentate is enriched in at least one cis-fatty acid ester.

In one embodiment the permeate is enriched in at least one saturated fatty acid ester and the retentate is enriched in at least one cis-fatty acid ester.

In one embodiment the mixture comprises stearic acid, linolenic acid, oleic acid and linoleic acid.

In one embodiment the mixture comprises the methyl esters of stearic acid, linolenic acid, oleic acid and linoleic acid.

In one embodiment the separation method results in an enriched amount of oleic acid, linoleic acid, linolenic acid, EPA or DHA.

In one embodiment the separation method results in an enriched amount of oleic acid ester, linoleic acid ester, linolenic acid ester, EPA ester or DHA ester.

In one embodiment the mixture comprises EPA ester and DHA ester.

In one embodiment the permeate is enriched in EPA ester.

In one embodiment the retentate is enriched in DHA ester.

In one embodiment the permeate is enriched in EPA ester and the retentate is enriched in DHA ester.

In one embodiment the permeate is enriched in EPA ester and DHA ester.

In one embodiment the EPA ester is EPA (C₁-C₆)alkyl ester or EPA (C₁-C₆)alkenyl ester and the DHA ester is DHA (C₁-C₆)alkyl ester or DHA (C₁-C₆)alkenyl ester.

In one embodiment the EPA ester is EPA ethyl ester and the DHA ester is DHA ethyl ester.

In one embodiment the mixture comprises EPA and DHA.

In one embodiment the permeate is enriched in EPA.

In one embodiment the retentate is enriched in DHA.

In one embodiment the permeate is enriched in EPA and the retentate is enriched DHA.

In one embodiment the permeate is enriched in EPA and DHA.

In one embodiment the solvent comprises toluene, hexane, methanol or methylene chloride or mixtures thereof.

In one embodiment the solvent comprises a hydrocarbon solvent, an alcohol solvent or a halogenated solvent or mixtures thereof.

In one embodiment the fatty acids do not include the salts of the fatty acids (e.g., the fatty acids are protonated fatty acids; “CO₂H”)

In one embodiment the fatty acids include fatty acid salts wherein the salts include alkali metal and alkaline earth metal salts.

In one embodiment the fatty acids include fatty acid salts wherein the salts include lithium, sodium, potassium, cesium, silver, calcium and magnesium salts.

In one embodiment the fatty acids do not include salts of the fatty acids (e.g., non-salt fatty acids or protonated fatty acids).

In one embodiment the fatty acids do not include fatty acids salts wherein the salts are positively charged amine salts.

In one embodiment the highly crosslinked polydicyclopentadiene membrane of the highly crosslinked polydicyclopentadiene composite membrane is obtainable by contacting polydicyclopentadiene with a reagent capable of crosslinking two or more double bonds of the polydicyclopentadiene.

In one embodiment the highly crosslinked polydicyclopentadiene membrane of the highly crosslinked polydicyclopentadiene composite membrane is obtained by contacting polydicyclopentadiene with a reagent capable of crosslinking two or more double bonds of the polydicyclopentadiene.

In one embodiment the highly crosslinked polydicyclopentadiene membrane of the highly crosslinked polydicyclopentadiene composite membrane is obtainable by contacting dicyclopentadiene with a ring-opening polymerization catalyst and a reagent capable of crosslinking two or more double bonds of polydicyclopentadiene.

In one embodiment the highly crosslinked polydicyclopentadiene membrane of the highly crosslinked polydicyclopentadiene composite membrane is obtained by contacting dicyclopentadiene with a ring-opening polymerization catalyst and a reagent capable of crosslinking two or more double bonds of polydicyclopentadiene.

In one embodiment the polydicyclopentadiene used to obtain the highly crosslinked polydicyclopentadiene composite membrane is obtainable from dicyclopentadiene through ring-opening metathesis polymerization.

In one embodiment the polydicyclopentadiene used to obtain the highly crosslinked polydicyclopentadiene composite membrane is obtained from dicyclopentadiene through ring-opening metathesis polymerization.

In one embodiment the polydicyclopentadiene used to obtain the highly crosslinked polydicyclopentadiene composite membrane is obtainable from dicyclopentadiene by treating the dicyclopentadiene with a ring-opening metathesis polymerization catalyst.

In one embodiment the polydicyclopentadiene used to obtain the highly crosslinked polydicyclopentadiene composite membrane is obtained from dicyclopentadiene by treating the dicyclopentadiene with a ring-opening metathesis polymerization catalyst.

In one embodiment the ring-opening metathesis polymerization catalyst is a Grubbs catalyst.

In one embodiment the reagent capable of crosslinking two or more double bonds of polydicyclopentadiene is not a Grubbs catalyst.

In one embodiment the reagent capable of crosslinking two or more double bonds of polydicyclopentadiene is not a ring-opening polymerization catalyst.

In one embodiment the reagent crosslinks the double bonds of the polydicyclopentadiene through a radical intermediate or through a cation intermediate.

In one embodiment the reagent which crosslinks the double bonds of the polydicyclopentadiene is a radical initiator or a cation initiator.

In one embodiment the reagent which crosslinks the double bonds of the polydicyclopentadiene is a radical initiator.

In one embodiment the reagent which crosslinks the double bonds of the polydicyclopentadiene is a peroxide.

In one embodiment the reagent which crosslinks the double bonds of the polydicyclopentadiene is benzoyl peroxide or diphenyliodonium-SbF₆.

In one embodiment the reagent which crosslinks the double bonds of the polydicyclopentadiene is a photoinitiator.

In one embodiment the reagent which crosslinks the double bonds of the polydicyclopentadiene is a cationic photoinitiator.

In one embodiment the reagent which crosslinks the double bonds of the polydicyclopentadiene is a diaryliodonium salt.

In one embodiment the reagent which crosslinks the double bonds of the polydicyclopentadiene is PC 2506.

In one embodiment the highly crosslinked polydicyclopentadiene composite membrane is characterized in that when it is contacted by a mixture comprising stearic acid, oleic acid and linoleic acid, the mixture is fractionated into a permeate and a retentate wherein the retentate is enriched in linoleic acid.

In one embodiment the porous support backing material is a polymeric material.

In one embodiment the polymeric material is a polysulfone, polycarbonate, polypropylene, polyamide, polyimine, polyphenylene ether or a halogenated polymer or a mixture thereof.

In one embodiment the porous support backing material is a metal mesh.

In one embodiment the highly crosslinked polydicyclopentadiene membrane comprises two or more highly crosslinked polydicyclopentadiene membranes.

In one embodiment the composite membrane is part of a spiral wound module.

In one embodiment the highly crosslinked polydicyclopentadiene membrane is part of a spiral.

One embodiment provides a method to separate a mixture of two or more different compounds or as described in any one of the proceeding embodiments, comprising contacting the mixture with a highly crosslinked polydicyclopentadiene composite membrane.

One embodiment provides a highly crosslinked polydicyclopentadiene membrane wherein the highly crosslinked polydicyclopentadiene membrane is obtainable by (a) contacting polydicyclopentadiene with a reagent capable of crosslinking two or more double bonds of the polydicyclopentadiene or (b) contacting dicyclopentadiene with a ring-opening polymerization catalyst and a reagent capable of crosslinking two or more double bonds of polydicyclopentadiene.

In one embodiment the highly crosslinked polydicyclopentadiene membrane is obtained by (a) contacting polydicyclopentadiene with a reagent capable of crosslinking two or more double bonds of the polydicyclopentadiene or (b) contacting dicyclopentadiene with a ring-opening polymerization catalyst and a reagent capable of crosslinking two or more double bonds of polydicyclopentadiene.

In one embodiment the polydicyclopentadiene used to obtain the highly crosslinked polydicyclopentadiene membrane is obtainable from dicyclopentadiene through ring-opening metathesis polymerization.

In one embodiment the polydicyclopentadiene used to obtain the highly crosslinked polydicyclopentadiene membrane is obtained from dicyclopentadiene through ring-opening metathesis polymerization.

In one embodiment the polydicyclopentadiene used to obtain the highly crosslinked polydicyclopentadiene membrane is obtainable from dicyclopentadiene by treating the dicyclopentadiene with a ring-opening metathesis polymerization catalyst.

In one embodiment the polydicyclopentadiene used to obtain the highly crosslinked polydicyclopentadiene membrane is obtained from dicyclopentadiene by treating the dicyclopentadiene with a ring-opening metathesis polymerization catalyst.

In one embodiment the ring-opening metathesis polymerization catalyst is a Grubbs catalyst.

In one embodiment the reagent capable of crosslinking two or more double bonds of polydicyclopentadiene is not a Grubbs catalyst.

In one embodiment the reagent capable of crosslinking two or more double bonds of polydicyclopentadiene is not a ring-opening polymerization catalyst.

In one embodiment the reagent which crosslinks the double bonds of polydicyclopentadiene is a cation initiator.

In one embodiment the reagent which crosslinks the double bonds of polydicyclopentadiene is a cationic photoinitiator.

In one embodiment the reagent which crosslinks the double bonds of polydicyclopentadiene is a diaryliodonium salt.

In one embodiment the reagent which crosslinks the double bonds of the polydicyclopentadiene is PC 2506.

In one embodiment the highly crosslinked polydicyclopentadiene membrane is characterized in that when the membrane is contacted with a mixture comprising stearic acid, oleic acid and linoleic acid, the mixture is fractionated into a permeate and a retentate wherein the retentate is enriched in linoleic acid.

One embodiment provides a method to separate a mixture of two or more different compounds or as described in any one of the above embodiments, comprising contacting the mixture with a highly crosslinked polydicyclopentadiene composite membrane as described in any one of the above embodiments.

The invention will now be illustrated by the following non-limiting Example.

### EXAMPLE 1

### Characterization and Measurements.

¹H NMR spectra were acquired on a Bruker DPX-500 NMR at 500 MHz and referenced to tetramethylsilane. The thicknesses of the membranes discussed herein were determined using a Micromaster microscope at the highest magnification. The cationic polymerization was completed using a BF 9H2 UV bulb from Fusion UV systems, Inc. All chemicals were purchased at their highest purity from Aldrich and Acros. The photoinitiator “PC 2506” was received from the Polyset company.

### Preparation of PDCPD Membranes.

This paragraph describes how the PDCPD membranes were fabricated at a loading of 5000/1 dicyclopentadiene/Grubbs catalyst ratio. A 20 mg mL⁻¹ solution of Grubbs first generation catalyst was made using 1,2-dichloroethane. A sample of this solution (0.72 mL, 6.0×10⁻³ mmol of catalyst) was added to 12 mL of dicyclopentadiene heated to 40° C. Heat was used to keep dicyclopentadiene (melting point 33° C.) a liquid. This solution was immediately placed between two glass slides with 100 μm thick paper as spacers along the edges. The sample was heated to 50° C. for 2 h and then removed from the glass slides.

This paragraph and the subsequent paragraph describe how PDCPD membranes were cross-linked using radical initiators to yield highly cross-linked PDCPD membranes including how a highly cross-linked PDCPD membrane with a dicyclopentadiene (DCPD)/benzoyl peroxide ratio of 2000/1 was fabricated. The ratio of DCPD/benzoyl peroxide refers to the loading of benzoyl peroxide in the PDCPD membrane prior to heating to cause the cross-linking to occur. The mass of a PDCPD membrane with a dimension of approximately 3.7 cm×3.7 cm×100 μm was measured to be 0.255 g (1.93×10⁻³ mol dicyclopentadiene). Based on this mass and the molecular weight for DCPD (132.20 g/mol), the PDCPD membrane had 1.93 mmol of dicyclopentadiene that was polymerized to yield PDCPD. For the calculations 1.93 mmol of DCPD was used. To fabricate a highly crosslinked membrane with a ratio of 2000/1 (DCPD/peroxide), 0.233 mg benzoyl peroxide (9.64×10⁻⁷ mol) was swelled inside the membrane.

Benzoyl peroxide (55.2 mg, 0.228 mol) was dissolved in 60 mL of dichloromethane in a jar. The PDCPD membrane was added to the jar and allowed to sit for 72 h. It was assumed that after 72 h benzoyl peroxide would partition between PDCPD membrane and dichloromethane solution. It was assumed that the concentration of benzoyl peroxide in dichloromethane would be equal to its concentration in PDCPD. Thus, 55.2 mg of peroxide in 60 mL dichloromethane would lead to approximately 0.233 mg of peroxide within the membrane after 72 h. After 72 h, the membrane was taken out of the solution and placed in a Schlenk flask. The membrane was evacuated for 2 h to remove dichloromethane. The Schlenk flask was evacuated and backfilled with nitrogen three times to remove the oxygen from the PDCPD membrane. The Schlenk flask was then sealed under vacuum and heated at 85° C. for 5 h. The highly crosslinked PDCPD membrane was then taken out of the Schlenk flask and used for separation experiments. For membranes with different DCPD/peroxide ratios, the same method was followed.

A second method to fabricate a highly cross-linked PDCPD membrane was also developed. In this method the DCPD and benzoyl peroxide were mixed together with optional solvent at a desired molar ratio of DCPD/peroxide. A ring-opening metathesis catalyst (e.g., Grubbs catalyst) was added to this mixture, mixed thoroughly, and a membrane was cast between two glass slides at 50° C. for 2 h as before. This membrane was then heated at 85° C. for 5 h under vacuum or N₂.

Polydicyclopentadiene membranes were also cross-linked using cationic initiators (e.g., PC 2506) to yield highly cross-linked PDCPD. Highly cross-linked PDCPD membrane with a DCPD/PC 2506 ratio of 5000/1 was fabricated. The ratio of DCPD/PC 2506 refers to the loading of PC 2506 in the PDCPD membrane prior to exposure to UV light to cause the cross-linking to occur. The mass of a PDCPD membrane with a dimension of approximately 3.7 cm×3.7 cm×100 μm was measured to be 0.226 g. Based on this mass and the molecular weight for DCPD (132.20 g/mol), the PDCPD membrane had 1.71 mmol of dicyclopentadiene that was polymerized to yield PDCPD. For the calculations 1.71 mmol of DCPD was used. To fabricate a highly crosslinked membrane with a ratio of 5000/1 (DCPD/ PC 2506), 0.25 mg PC 2506 (3.42×10⁻⁷ mol) was swelled inside the membrane.

The cationic photoinitiator PC2506 (66 mg) was dissolved in tetrahydrofuran (60 mL) in a jar. The PDCPD membrane was added to the jar and allowed to sit for 72 h. It was assumed that after 72 h PC 2506 would partition between the PDCPD membrane and tetrahydrofuran solution. It was assumed that the concentration of PC 2506 in tetrahydrofuran would be equal to its concentration in PDCPD. After 72 h, the membrane was taken out of the solution and placed in a Schlenk flask. The membrane was placed under vacuum for 2 h to remove tetrahydrofuran. The membrane was then placed under BF 9H2 UV bulb in a conveyer belt at the rate of 8 ft/min for 30 sec. This process yielded a highly crosslinked PDCPD membrane for separation experiments. For membranes with different DCPD/PC 2506 ratios, the same method was followed.

### Permeation Studies.

This paragraph describes how experiments were completed to investigate the permeation of stearic acid, oleic acid, and linoleic acid through highly cross-linked PDCPD membranes cross-linked with a radical initiator (Table 2). A highly cross-linked PDCPD membrane was added to the apparatus to study permeation. CH₂Cl₂ (25 mL) was added to the downstream side of the membrane and 25 mL of the same solvent was added to the upstream side of the membrane with 0.426 mmol of stearic acid, 0.426 mmol of oleic acid, and 0.426 mmol of linoleic acid. Solvent on both sides of the membrane were stirred continuously at room temperature. At 24, 48, and 72 h a 1 mL aliquot of solvent was removed from both sides of the membrane. The aliquots were used to determine the concentration of stearic acid, oleic acid, and linoleic acid by ¹H NMR spectroscopy. The S_{d}/Sᵤ values were found by the addition of known amounts of tetraethylene glycol as an internal standard to each aliquot. S_{d} is defined as the concentration of a molecule in solvent downstream of a membrane and Sᵤ is its concentration in solvent upstream of a membrane. Since the fatty acids are only initially added to the upstream solvent and none are added to the downstream solvent, the initial value for S_{d}/Sᵤ is 0. When the fatty acid has equilibrated and is found in equal concentrations in the solvent upstream and downstream of the membrane, the value for S_{d}/Sᵤ is 1.0.

This paragraph describes how the experiments were completed to investigate permeation of stearic acid and oleic acid through PDCPD membranes cross-linked with a radical initiator (Table 3). A highly cross-linked PDCPD membrane was added to the apparatus to study permeation. CH₂Cl₂ (25 mL) was added to the downstream side of the membrane and 25 mL of the same solvent was added to the upstream side of the membrane with 0.426 mmol of stearic acid, and 0.426 mmol of oleic acid. Solvent on both sides of the membrane were stirred continuously at room temperature. At 24, 48, 72 h, 96 h, and 120 h a 1 mL aliquot of solvent was removed from both sides of the membrane. The aliquots were used to determine the concentration of stearic acid and oleic acid by ¹H NMR spectroscopy. The S_{d}/Sᵤ values were found by the addition of known amounts of tetraethylene glycol as an internal standard to each aliquot.

This paragraph describes how the experiments were completed to investigate permeation of stearic acid, oleic acid, linoleic acid, and linolenic acid through highly cross-linked PDCPD membranes cross-linked with a cationic initiator (Table 4). A membrane was added to the apparatus to study permeation. CH₂Cl₂ (25 mL) was added to the downstream side of the membrane and 25 mL of the same solvent was added to the upstream side of the membrane with 0.426 mmol of stearic acid, 0.426 mmol of oleic acid, 0.426 mmol of linoleic acid, 0.426 mmol of linolenic acid. Solvent on both sides of the membrane were stirred continuously at room temperature. At 24, 48, and 72 h a 1 mL aliquot of solvent was removed from both sides of the membrane. The aliquots were used to determine the concentration of stearic acid, oleic acid, linoleic acid and linolenic acid by ¹H NMR spectroscopy. The S_{d}/Sᵤ values were found by the addition of known amounts of tetraethylene glycol as an internal standard to each aliquot.

This paragraph describes how the experiments were completed to investigate permeation of methyl esters of stearic acid, oleic acid, linoleic acid, and linolenic acid through PDCPD membranes cross-linked with a radical initiator (Table 5). A highly cross-linked PDCPD membrane was added to the apparatus to study permeation. CH₂Cl₂ (25 mL) was added to the downstream side of the membrane and 25 mL of the same solvent was added to the upstream side of the membrane with 0.4 mmol of methyl stearate, 0.4 mmol of methyl oleate, 0.4 mmol of methyl linoleate, 0.4 mmol of methyl linoleneate. Solvent on both sides of the membrane were stirred continuously at room temperature. At 24, 48, and 72 h a 1 mL aliquot of solvent was removed from both sides of the membrane. The aliquots were used to determine the concentration of the methyl esters of stearic acid, oleic acid, linoleic acid, and linolenic acid by ¹H NMR spectroscopy. The S_{d}/Sᵤ values were found by the addition of known amounts of tetraethylene glycol as an internal standard to each aliquot.

This paragraph describes how the experiments were completed to investigate the separation of fatty acids under pressure through highly crosslinked PDCPD membranes (Table 6). A highly crosslinked PDCPD membrane was added to a metal vessel. The membrane was added horizontally and placed on a metal mesh for support. CH₂Cl₂ (100 mL) was added to the upstream side of the membrane with 19.63 mmol (5.58 g) stearic acid, 19.63 mmol (5.55 g) oleic acid, and 19.63 mmol (5.50 g) linoleic acid. The valve on the downstream side was opened. CH₂Cl₂ (20 mL) was added to the downstream side of the membrane. The membrane was allowed to swell for 30 mins. After that time period, a valve on the upstream side was attached to a tank of N₂. The pressure was increased to 90 psi in 10 min. The pressure was constant at 90 psi during an induction period of 15-20 min where no solution permeated to the downstream side. After this induction period, the solution was collected on the downstream side in 25-35 min. A 1 mL aliquot of solvent was removed and a known amount of tetraethylene glycol was added. The absolute amounts of fatty acids were found by ^{I}H NMR spectroscopy. The solution left behind on the upstream side (i.e., the solvent that did not permeate the membrane) was collected and the absolute amounts of fatty acids were measured ¹H NMR spectroscopy.

This paragraph describes how the experiments to separate fatty acids under pressure through highly cross-linked PDCPD membranes modified using benzoyl peroxide were completed (Table 7). Importantly, no solvent was added, the fatty acids were their own solvent. A highly crosslinked PDCPD membrane was added to a metal vessel to study flux. The membrane was placed horizontally on a metal mesh for support. Technical grade linoleic acid (50 mL) from Sigma-Aldrich with the composition of 64% linoleic acid, 24.5% oleic acid, and 11.5% saturated acid was added to the vessel. The valve on the downstream side was opened. The membrane was allowed to swell for 30 mins. After that time period, a valve on the upstream side was attached to a tank of N₂. The pressure was increased to 160 psi in 20 min. The pressure was constant at 160 psi during an induction period of 45 min where no solution permeated to the downstream side. After this induction period, the solution was collected on the downstream side in 50 min. A 1 mL aliquot of solvent was removed and a known amount of tetraethylene glycol was added. The absolute amounts of fatty acids were found by ¹H NMR spectroscopy. The solution on the upstream side (i.e., the solution that did not permeate the membrane) was collected and the absolute amounts of fatty acids were measured by ¹H NMR spectroscopy.

This paragraph describes how experiments to separate the ethyl esters of EPA and DHA were completed as shown in Table 8. The ethyl ester of EPA (EPA-EE; ethyl eicosapentaenoic acid) and the ethyl ester of DHA (DHA-EE) were purchased from Icelandirect. The purity of EPA-EE was 75% (product ID: C-0120) and the purity of DHA-EE was 80% (product ID: C-0080). A highly crosslinked membrane modified using benzoyl peroxide was added to the apparatus to study permeation. CH₂Cl₂ (25 mL) was added to the downstream side of the membrane and 25 mL of the same solvent was added to the upstream side of the membrane with 0.5 mmol of EPA-EE, and 0.5 mmol of DHA-EE. Catechol (0.005 mmol) was added to both the upstream and downstream sides of the membrane to prevent oxidation of the fatty acids. Solvent on both sides of the membrane were stirred continuously at room temperature. At 24, 48, 72, 96, and 120 h a 1 mL aliquot of solvent was removed from both sides of the membrane. The aliquots were used to determine the concentration of EPA-EE and DHA-EE by ¹H NMR spectroscopy. The S_{d}/Sᵤ values were found by the addition of known amounts of tetraethylene glycol as an internal standard to each aliquot.

### Results and Discussion.

Membranes composed of PDCPD were fabricated by the ring opening metathesis polymerization of commercially available dicyclopentadiene using the Grubbs first generation catalyst at molar ratios of 5000/1 dicyclopentadiene/Grubbs catalyst. The membranes were approximately 100 microns thick. The membranes were robust and had reproducible properties.

To further cross-link these PDCPD membranes, a radical initiator (e.g., benzoyl peroxide) was swelled into the membrane for 72 h to ensure equilibration of the initiator between membrane and solvent. The solvent was removed and then the membrane was placed under nitrogen in a glass vessel. The membrane was then heated to 85° C. for 5 h to further cross-link it by a radical reaction. The membrane turned pale to dark yellow in the process depending on the ratio of the initiator to dicyclopentadiene. Scheme 6 illustrates the reaction scheme for the process of cross-linking the PDCPD membranes by radical reaction. The first step shows the polymerization of dicyclopentadiene by the Grubbs first generation catalyst to yield a cross-linked PDCPD membrane. The second step shows the radical crosslinking of a PDCPD membrane by benzoyl peroxide.

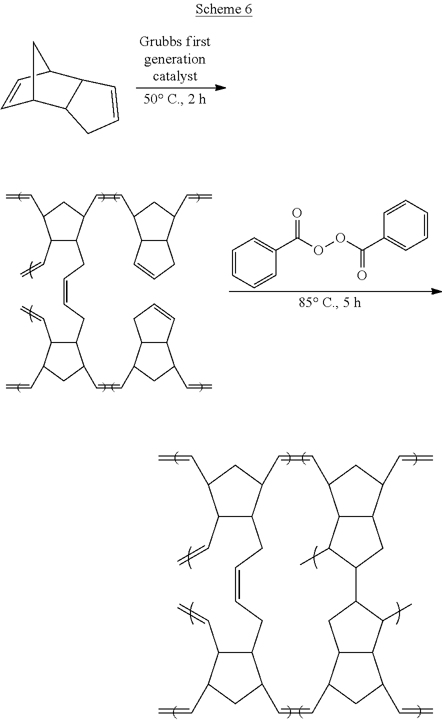

Another method to cross-link the PDCPD membranes used the cationic photoinitiator diaryliodonium salt (PC 2506). The membrane was swelled with the photoinitiator in tetrahydofuran under dry conditions. The membrane was then passed below UV light at the speed of 8 ft/min for 30 sec to activate the photoinitiator within the PDCPD matrix. Scheme 7 illustrates the reaction scheme for the process of cross-linking the PDCPD membranes by cationic reactions. The first step shows the polymerization of dicyclopentadiene by the Grubbs first generation catalyst to yield a cross-linked PDCPD membrane. The second step shows the crosslinking of a PDCPD membrane by photoinitiator PC 2506. Photoinitiator PC 2506 is a diaryliodonium salt.

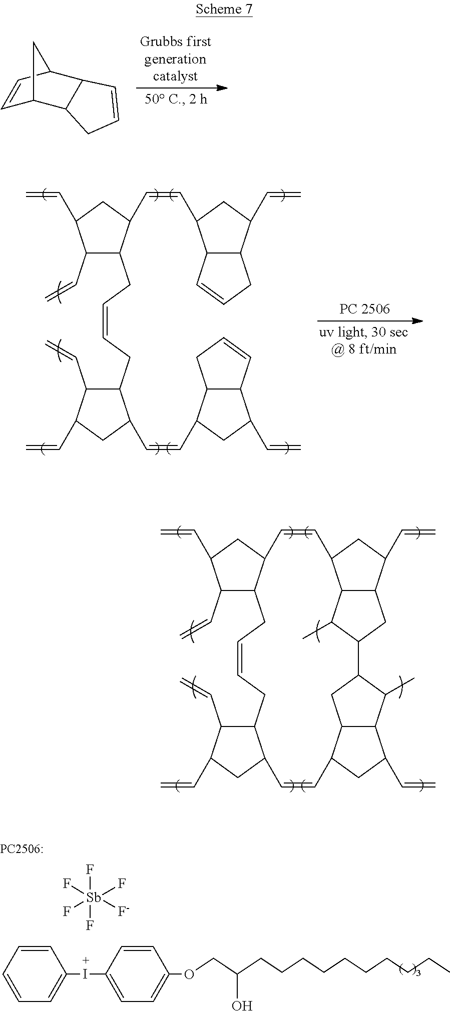

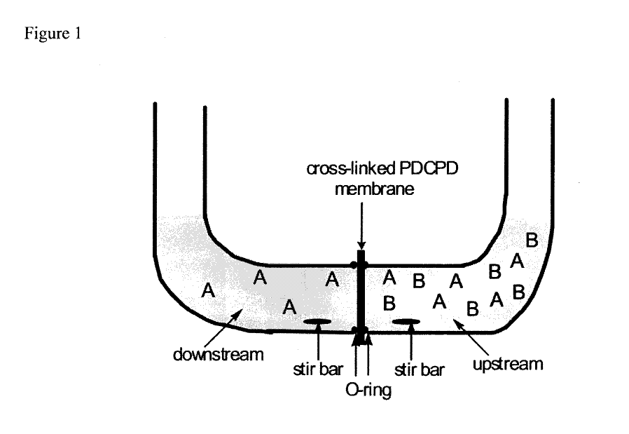

In most of the experiments described herein, the membranes were placed between two reservoirs of solvent and were held in place by a clamp (FIG. 1). The solvent on either side of the membrane was stirred continuously using a magnetic stir plate to eliminate boundary effects. In these experiments, the molecules studied for permeation were added to the solvent on the upstream side of the membrane. Molecules partitioned into the membrane, diffused through them and were found on to the downstream side of the membrane. After a period of time, usually 24 h, well-defined aliquots of solvent from both sides of the membrane were removed and the solvent was evaporated. An internal standard of tetraethylene glycol was added to each aliquot before being analyzed by ¹H NMR spectroscopy to measure the concentrations of the molecules on the upstream and downstream sides of the membrane.

The results of the separation of a mixture of stearic acid, oleic acid, and linoleic acid through the PDCPD membranes modified with benzoyl peroxide are summarized in Table 2. The DCPD/peroxide ratio refers to the ratio of polymerized dicyclopentadiene to benzoyl peroxide used to fabricate the highly cross-linked membranes as described earlier. In all experiments at 72 h, the stearic acid had the highest value for S_{d}/Sᵤ and the highest flux. The linoleic acid had the lowest values for S_{d}/Sᵤ and the slowest flux. The separation and flux was controlled by the initial loading of benzoyl peroxide in the membrane. These membranes were used to separate and purify stearic, oleic, and linoleic acids.

TABLE 2
Permeation of stearic acid, oleic acid, and linoleic acid
through PDCPD membranes modified using benzoyl peroxide.

| | DCPD/ | Stearic acid S_{d}/Sᵤ | | | Oleic acid S_{d}/Sᵤ | | | Linoleic acid S_{d}/Sᵤ | | |
|---|---|---|---|---|---|---|---|---|---|---|
| Entry | peroxide | 24 h | 48 h | 72 h | 24 h | 48 h | 72 h | 24 h | 48 h | 72 h |
| 1 | 1000/1 | 0.10 | 0.21 | 0.30 | 0.05 | 0.12 | 0.20 | 0 | 0.03 | 0.07 |
| 2 | 2000/1 | 0.33 | 0.47 | 0.8 | 0.26 | 0.37 | 0.69 | 0.06 | 0.08 | 0.17 |
| 3 | 3000/1 | 0.36 | 0.48 | 0.8 | 0.29 | 0.47 | 0.75 | 0.07 | 0.15 | 0.24 |
| 4 | 4000/1 | 0.43 | 0.61 | 1.00 | 0.33 | 0.57 | 0.9 | 0.17 | 0.27 | 0.41 |
| 5 | No peroxide | 0.45 | 0.70 | 1.00 | 0.33 | 0.72 | 1.00 | 0.24 | 0.41 | 0.99 |

The permeation of stearic acid and oleic acid through a PDCPD membrane modified with benzoyl peroxide at a 500/1 dicyclopentadiene/peroxide ratio is summarized in Table 3. This experiment was completed to demonstrate a membrane with a higher selectivity for permeation of stearic acid over oleic acid than the membranes used in Table 2. At 72 h the ratio of the values for Sd/Su for stearic acid to oleic acid was larger than the for the 500/1 membrane than those membranes reported in Table 2. This ratio for Sd/Su for stearic acid/oleic acid was 2.08 for the 500/1 membrane at 72 h and only 1.5 or less for membranes reported in Table 2.

TABLE 3
Permeation of stearic acid and oleic acid through
PDCPD membranes modified using benzoyl peroxide.

| | DCPD/ | Stearic acid S_{d}/Sᵤ | | | | | Oleic acid S_{d}/Sᵤ | | | | |
|---|---|---|---|---|---|---|---|---|---|---|---|
| Entry | peroxide | 24 h | 48 h | 72 h | 96 h | 120 h | 24 h | 48 h | 72 h | 96 h | 120 h |
| 1 | 500/1 | 0.07 | 0.13 | 0.25 | 0.5 | 0.8 | 0.03 | 0.06 | 0.12 | 0.24 | 0.4 |

The results for the permeation of stearic acid, oleic acid, linoleic acid, and linolenic acid through PDCPD membranes cross-linked with PC 2506 are summarized in Table 4. These membranes show that optimization of the membrane can be used to separate and purify stearic, oleic, linoleic, and linolenic acids. Tables 2-4 show that the ratio of DCPD/initiator is very important both for the flux and selectivity of the membrane. The membranes can be tuned to selectively retain different fatty acids which allows these membranes to purify multiple fatty acids.

TABLE 4
Permeation of stearic acid, oleic acid, linoleic acid, and linolenic
acid through PDCPD membranes modified with PC 2506.

| | DCPD/ | Stearic acid S_{d}/Sᵤ | | | Oleic acid S_{d}/Sᵤ | | | Linoleic acid S_{d}/Sᵤ | | | Linolenic acid S_{d}/Sᵤ | | |
|---|---|---|---|---|---|---|---|---|---|---|---|---|---|
| Entry | PC 2506 | 24 h | 48 h | 72 h | 24 h | 48 h | 72 h | 24 h | 48 h | 72 h | 24 h | 48 h | 72 h |
| 1 | 5000/1 | 0.1 | 0.2 | 0.25 | 0.06 | 0.12 | 0.17 | 0 | 0.03 | 0.07 | 0 | 0.02 | 0.06 |
| 2 | 10000/1 | 0.25 | 0.5 | 0.7 | 0.2 | 0.45 | 0.63 | 0.06 | 0.17 | 0.23 | 0.05 | 0.15 | 0.22 |
| 3 | 12000/1 | 0.29 | 0.55 | 0.75 | 0.23 | 0.5 | 0.65 | 0.1 | 0.18 | 0.25 | 0.09 | 0.16 | 0.23 |

The results of permeation of methyl esters of stearic acid, oleic acid, linoleic acid, and linolenic acid through PDCPD membranes cross-linked with benzoyl peroxide are summarized in Table 5. In all experiments at 72 h, the methyl ester of stearic acid had the highest flux and the methyl ester of linolenic acid had the slowest flux. The esters of polyunsaturated fatty acids had much slower rate of permeation through these membranes as compared to esters of oleic acid and stearic acid.

TABLE 5
Permeation of methyl esters of stearic acid, oleic acid, linoleic acid, and linolenic
acid through highly cross-linked PDCPD membranes modified with benzoyl peroxide.

| | DCPD/ | Methyl stearate S_{d}/Sᵤ | | | Methyl oleate S_{d}/Sᵤ | | | Methyl Linoleate S_{d}/Sᵤ | | | Methyl Linoleneate S_{d}/Sᵤ | | |
|---|---|---|---|---|---|---|---|---|---|---|---|---|---|
| Entry | peroxide | 24 h | 48 h | 72 h | 24 h | 48 h | 72 h | 24 h | 48 h | 72 h | 24 h | 48 h | 72 h |
| 1 | 2000/1 | 0.25 | 0.45 | 0.75 | 0.2 | 0.4 | 0.7 | 0.08 | 0.14 | 0.25 | 0.07 | 0.12 | 0.23 |
| 2 | 4000/1 | 0.39 | 0.56 | 0.97 | 0.32 | 0.51 | 0.9 | 0.2 | 0.28 | 0.45 | 0.19 | 0.26 | 0.43 |

In all the experiments described above, the polyunsaturated fatty acids had a much slower rate of permeation through these membranes as compared to stearic and oleic acid. No pressure was applied in these experiments, so the driving force for flux was the difference in concentration of the fatty acids between the upstream and downstream side of the membrane. Because the flux was very slow for the fatty acids, the use of pressure was investigated. Typical values for the flux of solvent through organic solvent nanofiltration membranes used in industry are approximately 10 L m⁻² h⁻¹.

The results of the experiments with pressure are summarized in Table 6. The cross-linked membrane was placed horizontally within a metal vessel, and 100 mL of CH₂Cl₂ with stearic acid, oleic acid, and linoleic acid were added to the vessel. CH₂Cl₂ was added to the downstream side of the membrane to swell the membrane. The vessel was then pressurized to 90 psi, and all of the solvent permeated in 45 min for entry 1 and 35 min for entry 2. The flux for entry 1 was 25.3 L m⁻² h⁻¹ and 32.5 L m⁻² h⁻¹ for entry 2. The flux of solvent decreased through the membranes as the degree of cross-linking increased from entry 2 to entry 1.

A 1:1:1 mixture of stearic acid, oleic acid, and linoleic acid at a concentration of 16.63 g of total fatty acids/100 mL of methylene chloride was used for both of the experiments listed in Table 6. The results showed that the stearic acid and oleic acid readily permeate through these membranes whereas linoleic acid was retained by these membranes. The purity of linoleic acid was approximately 64% at the beginning of the separation; after the separation the upstream linoleic acid was 96% pure (entry 1) and 97% (entry 2). These results indicated a high level of success both in the separation of polyunsaturated fatty acids from the saturated and monounsaturated fatty acids and in the overall recovery of these fatty acids.

TABLE 6
Permeation of stearic acid, oleic acid, and linoleic acid
through highly crosslinked PDCPD membranes under pressure.

| | | | Initial | Downstream | Upstream |
|---|---|---|---|---|---|
| | DCPD/ | | amount | solvent | solvent |
| Entry | peroxide | Molecule | (mmol) | (mmol) | (mmol) |
| 1 | 2000/1 | stearic acid | 19.63 | 19.43 | 0.15 |
| | | oleic acid | 19.63 | 19.04 | 0.49 |
| | | linoleic acid | 19.63 | 4.76 | 14.2 |
| 2 | 3000/1 | stearic acid | 19.63 | 19.4 | 0.16 |
| | | oleic acid | 19.63 | 19.2 | 0.3 |
| | | linoleic acid | 19.63 | 5.9 | 13.05 |

To investigate if a solvent was needed, a fatty acid solution (50 mL) with the composition of linoleic acid (0.114 mol), oleic acid (0.043 mol), and stearic acid (0.02 mol) was passed through a highly crosslinked membrane using 160 psi of pressure (Table 7). No solvent was added, the fatty acids were their own solvent. After an induction time of 45 min when no solution permeated to the downstream side, 28 mL of the fatty acids permeated to the downstream side in 50 min. The flux was calculated to be 6.4 L m⁻² h⁻¹. The upstream solution was collected. The upstream and downstream mixtures were analyzed by ¹H NMR spectroscopy. The initial mixture of fatty acid was an impure mixture of linoleic acid (64% linoleic acid, 24.5% oleic acid, and 11.5% saturated acid). After one pass through this membrane, the upstream mixture was purified to 98% linoleic acid. This demonstrates that these membranes can be used to purify a mixture of fatty acids without using any organic solvent.

TABLE 7
Permeation of stearic acid, oleic acid, and linoleic
acid through highly cross-linked PDCPD membranes
under pressure in the absence of organic solvent.

| | | | Initial | | |
|---|---|---|---|---|---|
| | DCPD/ | | amount | Downstream | Upstream |
| Entry | peroxide | Molecule | (mol) | (mmol) | (mmol) |
| 1 | 2000/1 | linoleic acid | 0.114 | 0.025 | 0.083 |
| | | oleic acid | 0.043 | 0.040 | 0.001 |
| | | stearic acid | 0.02 | 0.019 | 0.0005 |

The results of permeation of EPA-EE and DHA-EE through highly crosslinked PDCPD membranes modified with benzoyl peroxide are partially listed in Table 8. In all the experiments, EPA-EE had a higher flux as compared to DHA-EE. Based on the data points at 96 h, an increase in the ratio of DCPD/peroxide ratio lead to an increase in the difference between the flux of EPA-EE and DHA-EE. These results show that these membranes can be used to purify EPA-EE and DHA-EE.

TABLE 8
Permeation of EPA-EE and DHA-EE through highly crosslinked
PDCPD membranes modified using benzoyl peroxide.

| | DCPD/ | EPA-EE S_{d}/Sᵤ | | | | | DHA-EE S_{d}/Sᵤ | | | | |
|---|---|---|---|---|---|---|---|---|---|---|---|
| Entry | peroxide | 24 h | 48 h | 72 h | 96 h | 120 h | 24 h | 48 h | 72 h | 96 h | 120 h |
| 1 | 2000/1 | 0.02 | 0.11 | 0.24 | 0.35 | 0.75 | 0.01 | 0.06 | 0.12 | 0.15 | 0.34 |
| 2 | 5000/1 | 0.14 | 0.26 | 0.39 | 0.83 | 0.97 | 0.06 | 0.13 | 0.19 | 0.45 | 0.61 |
| 3 | 6000/1 | 0.13 | 0.35 | 0.52 | 1.02 | 1.06 | 0.06 | 0.21 | 0.3 | 0.55 | 0.75 |
| 4 | 10000/1 | 0.21 | 0.37 | 0.55 | 0.91 | 1.10 | 0.13 | 0.27 | 0.40 | 0.70 | 0.82 |

Experiments were completed with fish oil fatty acid esters under pressure. These experiments were completed as before in the absence of any added solvent utilizing the ethyl esters of the fatty acids. A membrane with a DCPD/peroxide loading of 1000/1 was prepared before and 50 mL of a mixture of ethyl esters of fatty acids were added to the reservoir above the membrane. Pressure (160 psi) was applied and 30 mL permeated and 18 mL were retained.

The starting mixture had 19.50 g of EPA-EE, 19.96 g of DHA-EE, and the remainder of the mixture were other ethyl esters. The permeate was enriched in EPA-EE (14.21 g of EPA-EE and 8.91 g of DHA-EE in the permeate) and the retentate was enriched in DHA-EE (5.29 g of EPA-EE and 10.70 g of DHA-EE in the retentate). These experiments demonstrated that EPA-EE could be separated from DHA-EE to produce streams rich in both EPA-EE and DHA-EE.

This experiment was repeated with a membrane with a DCPD/peroxide ratio of 500/1. 50 mL of a mixture of fish oil ethyl esters with the same composition as the previous experiment was added to reservoir above a membrane and pressurized to 160 psi. The permeate (30 mL) had a composition of 15.53 g of EPA-EE and 7.13 g of DHA-EE. The retentate (19 mL) had a composition of 3.31 g of EPA-EE and 11.76 g of DHA-EE. These experiments also demonstrate that EPA-EE can be separated from DHA-EE.

The membranes can separate molecules other than fatty acids/fatty acid esters based on their different sizes. To demonstrate this a series of four trisubstituted amines and p-nitrobenzaldehyde were studied for their flux through membranes fabricated with different loadings of DCPD/benzoyl peroxide. The amines were chosen based on their different critical areas as described in Table 9. The amines and p-nitrobenzaldehyde span a wide range of critical sizes that further demonstrate the ability of these membranes to separate molecules with different critical areas. The flux of these molecules were investigated by adding them to methylene chloride and studying their flux through a membrane as shown in FIG. 1.

TABLE 9
Critical areas of selected molecules.

| Entry | Molecule | Critical Area (nm²) |
|---|---|---|
| 1 | p-Nitrobenzaldehyde | 0.060 |
| 2 | Triethylamine | 0.18 |
| 3 | Tripropylamine | 0.32 |
| 4 | Triisobutylamine | 0.38 |
| 5 | Tributylamine | 0.50 |

The results of the flux experiments are shown in Table 10. The experiment with no peroxide present showed that the four of the five molecules had slight differences in their flux through the membranes with the fastest flux observed for the p-nitrobenzaldehyde. Importantly, the differences in flux followed the same trend as their critical areas. Tributylamine was too large to permeate the membrane. The differences in flux for the four molecules that did permeate was small for the PDCPD membranes.

When the loading of peroxide increased in the PDCPD membrane, the flux for the molecules decreased and the differences in flux between two molecules increased with the exception of tributylamine. For instance, when the DPCD/peroxide loading changed from 10,000/1 to 1,000/1 the flux of triethylamine decreased as shown by the decreasing values for Sd/Su at 24 h. This trend was generally observed for p-nitrobenzaldehyde, tripropylamine, and triisobutylamine too. This result demonstrated that increasing the amount of peroxide in the membrane could slow the permeation of a molecule.

Importantly, the difference in flux between molecules increased as the loading of peroxide increased and this difference can be used to separate them. To simplify the discussion we will refer to the Sd/Su values as these provide trends about the flux. For instance, the difference in Sd/Su at 24 h for triethylamine and tripropylamine was very small when no peroxide was used (0.40 versus 0.36) but the difference increased as the loading of peroxide increased from 10,000/1 (0.41 versus 0.37) to 5,000/1 (0.30 versus 0.24) to 3,000/1 (0.21 versus 0.09) to 1,000/1 (0.20 versus 0.08). The same trend for an increase in difference in Sd/Su was observed for p-nitrobenzaldehyde, triethylamine, tripropylamine, and triisobutylamine. The most striking result was the difference in values for Sd/Su between p-nitrobenzaldehyde and triisobutylamine. With no peroxide the difference in values for Sd/Su at 24 h were modest (0.46 versus 0.33) but with a DCPD/peroxide loading of 1,000/1 the difference in Sd/Su was greatly increased (0.37 versus 0.02).

These results demonstrate that changing the loading of DCPD/peroxide provides a method to increase the difference in flux between molecules with critical areas between 0.060 and 0.50 nm². These membranes can be used to separate a wide range of molecules.

A trend in Table 10 is that tributylamine did not permeate the PDCPD membrane made without any peroxide but it did permeate when peroxide was used to fabricate a membrane. The addition of peroxide changed the pore sizes to allow tributylamine to permeate.

TABLE 10
Permeation of five molecules through membranes
with different loadings of benzoyl peroxide.

| DCPD/ | p-Nitrobenzaldehyde S_{d}/Sᵤ | | | Triethylamine S_{d}/Sᵤ | | | Tripropylamine S_{d}/Sᵤ | | |
|---|---|---|---|---|---|---|---|---|---|
| peroxide | 24 h | 48 h | 72 h | 24 h | 48 h | 72 h | 24 h | 48 h | 72 h |
| 1000/1 | 0.37 | 0.76 | 0.79 | 0.20 | 0.44 | 0.69 | 0.08 | 0.18 | 0.30 |
| 3000/1 | 0.53 | 0.80 | 0.99 | 0.21 | 0.40 | 0.56 | 0.09 | 0.27 | 0.54 |
| 5000/1 | 0.44 | 0.92 | 1.00 | 0.30 | 0.73 | 0.93 | 0.24 | 0.58 | 0.63 |
| 10000/1 | 0.54 | 0.75 | 1.00 | 0.41 | 0.67 | 1.00 | 0.37 | 0.66 | 0.95 |
| No peroxide | 0.46 | 0.81 | 1.00 | 0.40 | 0.72 | 1.00 | 0.37 | 0.71 | 1.00 |

| DCPD/ | Triisobutylamine S_{d}/Sᵤ | | | Tributylamine Sd/Su | | |
|---|---|---|---|---|---|---|
| peroxide | 24 h | 48 h | 72 h | 24 h | 48 h | 72 h |
| 1000/1 | 0.02 | 0.06 | 0.10 | 0.03 | 0.07 | 0.09 |
| 3000/1 | 0.03 | 0.13 | 0.32 | 0.03 | 0.03 | 0.03 |
| 5000/1 | 0.11 | 0.24 | 0.38 | na | na | na |
| 10000/1 | 0.36 | 0.59 | 0.87 | 0.00 | 0.01 | 0.01 |
| No peroxide | 0.33 | 0.65 | 0.88 | 0.00 | 0.00 | 0.00 |

Measurement and comparison of critical areas. The measurement of the critical area of molecules has been previously described in U.S. Pat. No. 8,778,186 and International Patent Application WO2014/088607 and Gupta, A.; Rethwisch, D. G.; Bowden, N. B. Chem. Commun. 2011, 46, 10236 which methods to measure critical area are hereby incorporated by reference. In cross-linked polymer matrixes the diffusion, D, of a molecule depends exponentially on the energy of activation, Eₐ (kcal mol⁻¹) according to the equation D=D₀exp(−Eₐ/RT) (Crank, J. The mathematics of diffusion; Clarendon Press: Oxford, 1970). Compounds (i.e., molecules) that are much smaller than the pores in a matrix can diffuse rapidly because the polymer matrix does not have to rearrange to allow them to diffuse. Molecules that are on the same size as the pores or larger than the pores diffuse slowly because the polymer matrix must deform and the value for Eₐ is large. In practice, the rate of diffusion in cross-linked polymers has been shown to be heavily dependent on the cross-sectional areas of molecules. For instance, in 1982 Berens and Hopfenberg plotted the log of diffusion versus the square of diameter for 18 molecules that permeated poly(vinyl chloride), polystyrene, and polymethymethacrylate (Berens, A. R.; Hopfenberg, H. B. J. Mem. Sci. 1982, 13, 283). The diffusion of He (diameter squared=6.66×10⁻² nm²) was ten orders of magnitude faster than the diffusion of neopentane (diameter squared=3.36×10⁻¹ nm²). PDCPD was a highly cross-linked polymer matrix and the rate of diffusion of molecule was expected to depend on their critical areas. It has been shown that molecules above a critical area of 0.50 nm² did not permeate PDCPD membranes but molecules with cross-sectional areas below 0.38 nm² did permeate.

One challenge in the field of size-selective membranes is defining the critical area of a molecule. This is usually not attempted; rather, membranes are described as possessing a “molecular weight cutoff” that is used to determine whether a new molecule will permeate (Fierro, D.; Boschetti-de-Fierro, A.; Abetz, V. J. Membr. Sci. 2012, 413-414, 91; Fritsch, D.; Merten, P.; Heinrich, K.; Lazar, M.; Priske, M. J. Membr. Sci. 2012, 401-402, 222; Rundquist, E. M.; Pink, C. J.; Livingston, A. G. Green Chem. 2012, 14, 2197; Sereewatthanawut, I.; Lim, F. W.; Bhole, Y. S.; Ormerod, D.; Horvath, A.; Boam, A. T.; Livingston, A. G. Org. Process Res. Dev. 2010, 14, 600; So, S.; Peeva, L. G.; Tate, E. W.; Leatherbarrow, R. J.; Livingston, A. G. Org. Process Res. Dev. 2010, 14, 1313; Szekely, G.; Bandana, J.; Heggie, W.; Sellergren, B.; Ferreira, F. C. J. Membr. Sci. 2011, 381, 21; and van, d. G. P.; Barnard, A.; Cronje, J.-P.; de, V. D.; Marx, S.; Vosloo, H. C. M. J. Membr. Sci. 2010, 353, 70

The critical areas for the molecules in this study were found using Spartan '08 V1.2.0. The compounds including for example the free fatty acids were constructed and their energies were minimized in Spartan. The molecules were rotated until the smallest rectangular cross-sectional area was found, and this value was labeled the critical area. The critical area was measured because this area was the smallest size for the pore that each molecule may diffuse through.

In one embodiment the critical area of a compound is the lowest (smallest) rectangular cross-sectional area of the molecule in its energy minimized conformation.

All publications, patents, and patent documents discussed herein are incorporated by reference herein, as though individually incorporated by reference. The invention has been described with reference to various specific and preferred embodiments and techniques. However, it should be understood that many variations and modifications may be made while remaining within the spirit and scope of the invention.

1-139. (canceled)

140. A method comprising contacting a highly crosslinked polydicyclopentadiene membrane with a mixture of two or more different compounds, so that the mixture is fractionated into a permeate and a retentate, wherein the permeate or retentate is enriched in one or more of the compounds, and wherein the highly crosslinked polydicyclopentadiene membrane is obtainable by (a) contacting polydicyclopentadiene with a reagent cable of crosslinking two or more double bonds of the polydicyclopentadiene or (b) contacting dicyclopentadiene with a ring-opening polymerization catalyst and a reagent capable of crosslinking two or more double bonds of polydicyclopentadiene.

141. The method of claim 140, wherein the highly crosslinked polydicyclopentadiene membrane is obtained by (a) contacting polydicyclopentadiene with a reagent cable of crosslinking two or more double bonds of the polydicyclopentadiene or (b) contacting dicyclopentadiene with a ring-opening polymerization catalyst and a reagent capable of crosslinking two or more double bonds of polydicyclopentadiene.

142. A method comprising:
(a) contacting a membrane with a mixture of two or more different fatty acids, so that the mixture is fractionated into a permeate and a retentate, wherein the permeate or retentate is enriched in one or more of the fatty acids; or
(b) contacting a membrane with a mixture of two or more different fatty acid esters, so that the mixture is fractionated into a permeate and a retentate, wherein the permeate or retentate is enriched in one or more of the fatty acid esters.

143. The method of claim 142, wherein the membrane is a highly crosslinked polydicyclopentadiene.

144. The method of claim 143, wherein the highly crosslinked polydicyclopentadiene is obtainable by (a) contacting polydicyclopentadiene with a reagent capable of crosslinking two or more double bonds of the polydicyclopentadiene; or (b) by contacting dicyclopentadiene with a ring-opening polymerization catalyst and a reagent capable of crosslinking two or more double bonds of polydicyclopentadiene.

145. The method of claim 140, wherein the reagent which crosslinks the double bonds of polydicyclopentadiene is a radical initiator or a cation initiator.

146. The method of claim 144, wherein the reagent which crosslinks the double bonds of polydicyclopentadiene is a radical initiator or a cation initiator.

147. The method of claim 140, wherein the mixture of two or more different compounds comprises one or more compounds with critical areas of less than about 0.50 nm² and the mixture is fractionated into a permeate and a retentate, wherein the permeate is enriched in one or more the compounds with critical areas of less than about 0.50 nm².

148. The method of claim 140, wherein the mixture of two or more different compounds is (a) a mixture of two or more different fatty acids wherein the mixture is fractionated into a permeate and a retentate, wherein the permeate or retentate is enriched in one or more of the fatty acids or (b) a mixture of two or more different fatty acid esters wherein the mixture is fractionated into a permeate and a retentate, wherein the permeate or retentate is enriched in one or more of the fatty acid esters.

149. The method of claim 148, wherein the mixture of two or more different fatty acids comprises one or more fatty acids with critical areas of less than about 0.50 nm², and the mixture is fractionated into a permeate and a retentate, wherein the permeate is enriched in one or more of the fatty acids with critical areas of less than about 0.50 nm².

150. The method of claim 148, wherein the mixture of two or more different fatty acid esters comprises one or more fatty acid esters with cross-sectional areas of less than about 0.50 nm², and the mixture is fractionated into a permeate and a retentate, wherein the permeate is enriched in one or more of the fatty acid esters with cross-sectional areas of less than about 0.50 nm².

151. The method of claim 140, wherein the mixture comprises an eicosapenteanoic acid ester and a docosahexaenoic acid ester.

152. The method of claim 151, wherein the permeate is enriched in an eicosapenteanoic acid ester.

153. A highly crosslinked polydicyclopentadiene composite membrane wherein the highly crosslinked polydicyclopentadiene membrane is in contact with a porous support backing material and wherein the highly crosslinked polydicyclopentadiene membrane is obtainable by (a) contacting polydicyclopentadiene with a reagent capable of crosslinking two or more double bonds of the polydicyclopentadiene or (b) contacting dicyclopentadiene with a ring-opening polymerization catalyst and a reagent capable of crosslinking two or more double bonds of polydicyclopentadiene.

154. The highly crosslinked polydicyclopentadiene composite membrane of claim 153, wherein the highly crosslinked polydicyclopentadiene membrane is obtained by (a) contacting polydicyclopentadiene with a reagent capable of crosslinking two or more double bonds of the polydicyclopentadiene; or (b) by contacting dicyclopentadiene with a ring-opening polymerization catalyst and a reagent capable of crosslinking two or more double bonds of polydicyclopentadiene.

155. The highly crosslinked polydicyclopentadiene composite membrane of claim 153, wherein the polydicyclopentadiene is obtainable from dicyclopentadiene through ring-opening metathesis polymerization.

156. The highly crosslinked polydicyclopentadiene composite membrane of claim 153, wherein the reagent capable of crosslinking two or more double bonds of polydicyclopentadiene is not a ring-opening polymerization catalyst.

157. The highly crosslinked polydicyclopentadiene composite membrane of claim 153, wherein the reagent crosslinks the double bonds of the polydicyclopentadiene through a radical intermediate or through a cation intermediate.

158. A highly crosslinked polydicyclopentadiene membrane wherein the highly crosslinked polydicyclopentadiene membrane is obtainable by (a) contacting polydicyclopentadiene with a reagent cable of crosslinking two or more double bonds of the polydicyclopentadiene or (b) contacting dicyclopentadiene with a ring-opening polymerization catalyst and a reagent capable of crosslinking two or more double bonds of polydicyclopentadiene.

159. The highly crosslinked polydicyclopentadiene membrane of claim 158, wherein the reagent which crosslinks the double bonds of polydicyclopentadiene is a cation initiator.
